(19) United States
(12) Patent Application Publication
(10) Pub. No.: US 2001/0018721 A1
(43) Pub. Date: Aug. 30, 2001

(54) Upgrade card for a computer system

(76) Inventors: Daniel McKenna, Corvallis, OR (US); Neville Clark, Corvallis, OR (US); Michael Thompson, Eugene, OR (US)

Correspondence Address: Kevin L. Russell, 601 SW Second Ave., Suite 1600, Portland, OR, 97204-3157, US

(21) Appl. No.: 09/848,485

(22) Filed: May 3, 2001

Related U.S. Application Data
(63) Continuation of application No. 09/163,271, filed on Sep. 29, 1998.

(51) Int. Cl. G06F 13/38; G06F 13/40

(52) U.S. Cl. 710/126

(57) ABSTRACT

A processor upgrade on a card suitable to be interconnected with an industry standard PCI bus.

### BACKGROUND OF THE INVENTION

The present invention relates to a card supporting a processor for upgrading a computer system.

Personal computer manufacturers are constantly improving computer system performance because consumers are consistently demanding more performance from their computer systems. Traditionally consumers upgrade four aspects of their computer system, namely, (1) processor speed and functionality, (2) memory speed and size, (3) visual quality (video capability), and (4) input/output performance. Computer manufacturers primarily improve computer performance through technological advances in the processes used to fabricate the integrated devices within the computer and/or through hardware or software design improvements. Computer manufacturers, and in particular personal computer manufacturers, strive to implement these technological or design advances into products as soon as possible to meet ever increasing consumer demands.

With rapid advancements in computer technology a computer system can become obsolete in a relatively short amount of time. Consequently, computer owners often desire to upgrade their computer system to incorporate the latest advances in technology in the most cost effective and easily managed manner.

One way in which a consumer may upgrade their computer system is by replacing the primary printed circuit (PC) board (often referred to as the motherboard) that is housed within the computer system. The motherboard of a computer system commonly supports and interconnects the main processor device, a clock generation device, and other integrated devices and components that determine the functionality of the system. Replacement of the motherboard provides advantages, such as for example, a faster more powerful processor, improved memory technology, and improved input/output devices. However, replacing the motherboard as a unit tends to be a narrow upgrade path for the consumer since it is limited by the physical constraints of the box in which the motherboard resides. The motherboard jumpers must be set and the system connectors must be connected to the proper locations on the motherboard. In addition, the operating system typically must be reloaded on the computer system to be configured for the new motherboard. With the reinstallation of the operating system, the application software is then reinstalled at substantial expense and usually significant frustration. Frequently, several add-in cards must be upgraded or replaced. Further, compatibility issues typically arise between existing add-in cards and the new motherboard which must be resolved, if possible. In summary, the replacement of the motherboard of a computer system involves substantial compatibility issues and significant potential frustration to the user. Studies have shown that it is frequently less expensive to replace the entire personal computer system than attempt to upgrade the motherboard.

Another upgrade option is to replace the current processor device residing on the motherboard with a new upgraded processor device. In general, upgraded processors are designed to be faster and provide newer features than their predecessors due to newly developed technologies and circuit designs. As a result consumers can upgrade the speed of their computer system by replacing their current processor device.

Since the upgraded processor has increased speed capability, it typically has different clocking requirements than that which is provided by the clock generation device residing on the original motherboard. Consequently, to take advantage of the new processor's increased speed, the original clock signal from the motherboard is often multiplied up to a rate at which the new processor can operate. Increasing the rate of the motherboard clock is typically performed internally by the processor device with additional phase-locked-loop (PLL) circuitry.

A disadvantage of upgrading the processor is the new processor chip is designed to upgrade only that particular motherboard design. The reason for this is the processor's input/output bus is designed to have a communication protocol that is adaptable to a particular motherboard design. Further, the PLL of the processor device is tuned to increase the clock rate for a given fixed motherboard clock rate. As a result consumers may be limited to which processor they can upgrade with.

Upgrading with a new processor may also be done without adapting the clock rate of the motherboard to the new processor. However, in this case, the speed advantages provided by the new processor are not realized and thus this upgrade option is greatly limited.

Another disadvantage of replacing the processor device occurs in the case in which a computer manufacturer offers a range (or family) of computer systems allowing consumers to choose within the family in order to satisfy their processing needs. Commonly, the family of processors offer different processing options. In order to provide these various options, each family member has a corresponding different motherboard design adapted to a particular processor chip. Due to the fact that each family member has a different motherboard design, a processor device that can be used to upgrade one family member cannot be employed for upgrading another family member. For example, it might not be possible to upgrade a lower-end processor in the family with the same processor device as a higher-end processor. Thus, once again a particular motherboard's upgradeability may be limited by whether an upgraded processor device is available.

Mori et al., U.S. Pat. No. 4,716,526, disclose a multiprocessor system composed of multiple CPU cards plugged into a processor bus on a motherboard that has memory and I/O circuits. An arbitration mechanism allows the system to use different types of CPU's on each CPU card and controls access to the processor bus. The processor bus is connected directly to each CPU on each CPU card. Unfortunately, such an upgraded CPU card cannot be installed within most personal computers because the processor bus is fabricated on the motherboard and is not accessible to an upgraded card. A processor direct bus, as disclosed by Mori et al., is not a standard I/O (input/output) bus found in most personal computers, such as a PCI bus, EIDE bus, or an ISA bus. Further, only one processor at a time is permitted to be operating with this architecture.

Anzelone et al., U.S. Pat. No. 5,162,979, disclose a Microchannel CPU card with an elaborate insertion, removal, and locking mechanism. The system architecture locates the CPU, cache, memory controller, and bus controller on the CPU card. The interface between the CPU card and the motherboard is a proprietary bus and not an industry standard bus. Most personal computers do not include such a proprietary bus.

Lu et al., U.S. Pat. No. 5,297,272, disclose a 386SX CPU upgrade card that plugs into a proprietary processor direct socket on the motherboard to upgrade a 286 host system. The host 286 CPU is disabled and effectively replaced by plugging in the 386SX upgrade card. The use of a proprietary processor direct socket on the motherboard for CPU upgrades is not a standard I/O bus found in most personal computers, such as a PCI bus, EIDE bus, or an ISA bus. Lu et al., U.S. Pat. No. 5,321,827, extends the technique to include a 486 CPU upgrade card.

Bealkowski et al., U.S. Pat. No. 5,355,489, disclose a Microchannel CPU card. The computer system architecture puts the CPU, cache, memory controller, and bus controller on the CPU card. The motherboard has memory, I/O, and expansion slots. The interface between the CPU card and the motherboard is a proprietary bus and not an industry standard bus, such as the PCI bus, EIDE bus, or the ISA bus.

Begun et al., U.S. Pat. No. 5,381,541, disclose a multiprocessor CPU card for a Microchannel system. The computer system architecture locates multiple CPU's, multiprocessor arbitration logic, cache, memory controller, bus controller, and multiprocessor interrupt director on the CPU card. The motherboard has memory, I/O, and expansion slots. The interface between the CPU card and the motherboard is a proprietary bus and not an industry standard bus such as the PCI bus, EIDE bus, or the ISA bus.

Dhuey et al., U.S. Pat. No. 5,515,514, Yazdy et al., U.S. Pat. No. 5,600,802, and Yazdy et al., U.S. Pat. No. 5,603,007, disclose a Power PC CPU card upgrade for a 68040 microprocessor based system. In particular, Dhuey et al. describe a technique for disabling the host 68040 CPU and running a Power PC CPU in its place. The CPU card plugs into a proprietary processor direct bus interface and has on-board cache and a bus translation unit which converts Power PC bus cycles to 68040 bus cycles when accessing system memory. A processor upgrade that uses a processor direct bus interface is logically equivalent to CPU socket-based CPU upgrades. The upgrade card must plug into a proprietary processor direct socket on the host system motherboard. The CPU card completely disables the host processor so it is no longer active.

Sangveraphunsiri, U.S. Pat. No. 5,530,620, discloses a computer system with externally accessible upgrade capability. The computer system uses a proprietary processor direct upgrade slot connector.

Rotier et al., U.S. Pat. No. 5,586,270, disclose a credit card sized CPU upgrade module, including an upgrade CPU and optional cache memory, suitable for notebook computers. The CPU upgrade module uses a processor direct interface and disables the existing CPU in the notebook computer upon the module being inserted into a mating receptacle in the computer.

Polzin et al., U.S. Pat. No. 5,644,760, disclose a computer system architecture that uses a replaceable CPU card. The replaceable CPU card includes a CPU and a CPU clocking circuit. The interface to the CPU card is a processor direct bus interface combined with a clock bus interface. The system motherboard into which the CPU card is installed does not include a CPU. The CPU card uses a proprietary processor direct non-industry standard interface to the motherboard, unlike a PCI bus, EIDE bus, or ISA bus.

Adan et al., U.S. Pat. No. 4,794,523, disclose a CPU replacement upgrade module that plugs into the motherboard CPU socket replacing the existing CPU. The CPU upgrade architecture uses on-module cache memory and a faster upgrade CPU to enhance performance. The use of high-speed cache memory on the upgrade module increases memory access speed which improves overall system performance.

Zuk, U.S. Pat. No. 5,062,041, discloses a computer system architecture that allows synchronization between a processor and a co-processor at the macro and microinstruction levels.

Rutman, U.S. Pat. No. 5,313,586, discloses a VRAM technique for coupling multiple processors in multiprocessor computer system. The VRAM memory is used as a communication channel between processors.

Baqai et al., U.S. Pat. No. 5,410,726, disclose a computer system with an OverDrive™ chip and socket. Baqai et al. disclose a method for disabling the motherboard CPU by inserting an upgrade CPU in a special upgrade CPU socket. The upgrade CPU takes over operation of the system and the original CPU is non-functional.

Harwer et al., U.S. Pat. No. 5,440,755, disclose standard I/O bus slots on a riser card where the bus translation logic is on the riser card. Harwer et al. further describe partitioning the motherboard to allow various standard bus interfaces to be added easily to the base motherboard. The focus of Harwer et al. is on flexibility and expandability in adding bus slots to the motherboard using a riser card with bus decoding logic on it.

Madter et al., U.S. Pat. No. 5,450,574, disclose a 386SX upgrade card for a 286 host computer system that plugs into the 286 CPU socket after removal of the original 286 CPU. Madter et al. further disclose clock circuits for CPU socket-based replacement upgrades.

Huang, U.S. Pat. No., 5,455,927, discloses a motherboard that has 386/387 CPU/FPU sockets and a 486 CPU upgrade socket. Plugging a 486 chip into the upgrade socket disables the existing 386 CPU and runs the 486 as the main system CPU. The motherboard includes a main CPU socket and an upgrade CPU socket together with clock selection and synchronization circuitry, original CPU disabling circuitry, a co-processor interface, and bus compatibility circuits.

Shen et al., U.S. Pat. No. 5,493,655, and Golbert et al., U.S. Pat. No. 5,490,279, each disclose a computer system architecture that has two CPU sockets. The computer system can operate with either one or two CPU's installed. The addition of a second CPU to such a computer system that already has a first CPU is an upgrade from a uniprocessor system to a dual-processor system.

Tsukada et al., U.S. Pat. No. 5,502,617, disclose a credit card sized computer.

Madter, U.S. Pat. No. 5,506,981, discloses a 386SX upgrade card for a 286 host computer system that plugs into the 286 CPU socket after removal of the original 286 CPU.

Lee, U.S. Pat. No. 5,748,912, discloses a computer system, such as a notebook computer, suitable to work together with a credit card sized user-removable CPU/memory/bus bridge card. The computer system is designed to accommodate the card with a suitable interface.

Chuang, U.S. Pat. No. 5,546,563, discloses a computer system architecture with two CPU sockets. The motherboard logic detects the type of processor installed in each socket and configures clock lines and other CPU signal lines as appropriate for the processors installed. The upgrade CPU installed in one of the sockets takes over operation of the system and the original CPU is nonfunctional. The upgrade CPU socket uses a processor direct interface.

Chuang et al., U.S. Pat. No. 5,551,012, disclose a single CPU socket system that automatically detects the type of CPU installed and configures the computer system accordingly. The upgrade is through chip replacement in the single CPU socket.

Lunsford et al., U.S. Pat. No. 5,590,363, disclose a circuit for detecting the presence of a co-processor in a co-processor socket, with the generation of co-processor READY signal if the co-processor is absent. This is used to eliminate jumper configuration of the motherboard for the presence or absence of a co-processor.

Parks et al., U.S. Pat. No. 5,600,801, disclose an EISA bus intelligent SCSI card. Parks et al. describe a technique for using dual ported RAM to do board initialization and configuration.

Liu et al., U.S. Pat. No. 5,675,772, disclose a computer system architecture that supports multiple types of CPUs within one system. Liu et al. describe how to boot, configure, select processors, and operate such a system. The translation of each CPU bus to a common platform bus is used to allow sharing of memory and I/O subsystems within the system architecture.

Kim et al., U.S. Pat. No. 5,678,011, disclose a CPU on a replaceable daughtercard that includes configuration jumpers. Kim et al. describe a CPU daughtercard/motherboard architecture that allows the system CPU to be replaced by changing the daughtercard. The daughtercard contains configuration jumpers/switches that control the motherboard mounted CPU clock circuits. Such an architecture allows the replacement daughtercard to be pre-configured so the user does not have to be concerned with reconfiguring the base motherboard when replacing the CPU. The daughtercard described by Kim et al. uses a proprietary processor direct interface/connector and is a replacement for the original host CPU daughtercard.

Cohen et al., U.S. Pat. No. 5,737,524, disclose a PCI card with programmable configuration registers. Cohen et al. describe a PCI card architecture that has an on-board microprocessor, memory, and other functional devices (e.g. network adapter), and a PCI bus interface chip. Cohen et al. is directed to a technique for a PCI card microprocessor to configure registers in the PCI bus interface chip prior to the system CPU reading the PCI bus interface chip configuration registers. Cohen et al. describe a general technique for configuring the PCI bus interface devices prior to the host system CPU reading the configuration information from the PCI bus interface device.

Sonobe, U.S. Pat. No. 5,740,377, discloses a CPU upgrade with on-board memory that plugs into a CPU socket on a host system motherboard. In particular Sonobe describes a 486 upgrade module that plugs into a 486 system or an OverDrive™ CPU socket, and includes memory on the upgrade module. The host CPU is disabled and essentially replaced by the upgrade module CPU.

Font, European patent application number EP 0,656,586A1, discloses a computer system architecture using a special co-processor upgrade socket to allow a CPU upgrade module to be plugged into the upgrade socket and have the system BIOS recognize and configure the new processor. A CPU recognition and configuration scheme is described for the architecture to allow the user to select and configure either the original or the upgrade processor to run the system. The computer system requires processor direct bus attachment of the upgrade processor using a proprietary upgrade processor socket.

Stancil, International Publication Number PCT/US93/04005, discloses a circuit that allows a 486 CPU to upgrade a 386 computer system by simply inserting the 486 CPU in a special socket, while leaving the 386 CPU in place, albeit non-operational.

What is desired, therefore, is a CPU upgrade suitable for an industry standard architecture found on most computer systems. The CPU upgrade should provide increased processor speed and functionality, and increased memory speed and size. The CPU upgrade should not involve changing any motherboard settings, not involve BIOS changes to the computer system, not involve reinstallation of existing software, not involve incompatibility issues, not involve clocking issues, and be suitable for all standard Intel compatible x86 PCI motherboard designs. In addition, the CPU upgrade should be transparent to the user, not require the installation of any software, and be operating system independent.

### SUMMARY OF THE INVENTION

The present invention overcomes the aforementioned drawbacks of the prior art by providing a processor upgrade on a card suitable for interconnection with an industry standard PCI bus.

Preferably the operating system is loaded into the upgrade card which includes a processor which operates together with the processor on the host computer system. The addition of an additional PCI based upgrade card permits the upgrade card to include increased processor speed and functionality, and increased memory speed and size. The upgrade processor card preferably permits the host system to perform a complete power-on-self-test prior to obtaining control of the computer system and loading the operating system. In such a manner the upgrade card does not involve changing any motherboard settings, does not involve BIOS changes to the host computer system, does not involve reinstallation of existing software, does not involve incompatibility issues, does not involve clocking issues, and is suitable for all standard Intel compatible x86 PCI motherboard designs. In addition, by incorporating the operational software for the upgrade card within the ROM and transferred into the host system memory during the host POST the CPU upgrade is transparent to the user, does not require the installation of any software, and is operating system independent.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1 is an exemplary embodiment of a computer system including a processor upgrade card of the present invention.

FIG. 2 is a flow chart of a portion of the startup operation of the computer system of FIG. 1.

FIG. 3 is flow chart of another portion of the startup operation of the computer system of FIG. 1.

FIG. 4 is a schematic of the processor upgrade card of FIG. 1 including an ETI circuit.

FIG. 5 is an alternative embodiment of the processor upgrade card of FIG. 1 including an ETI circuit.

FIG. 6 is an exemplary schematic of the ETI circuit of FIG. 4.

FIG. 7 is an exemplary schematic of the ETI circuit of FIG. 5.

FIG. 8 is a more detailed exemplary schematic of the processor upgrade card of FIG. 4.

FIGS. 9-19 are an exemplary set of circuit diagrams for the upgrade card of FIG. 4.

### DETAILED DESCRIPTION OF THE PREFERRED EMBODIMENT

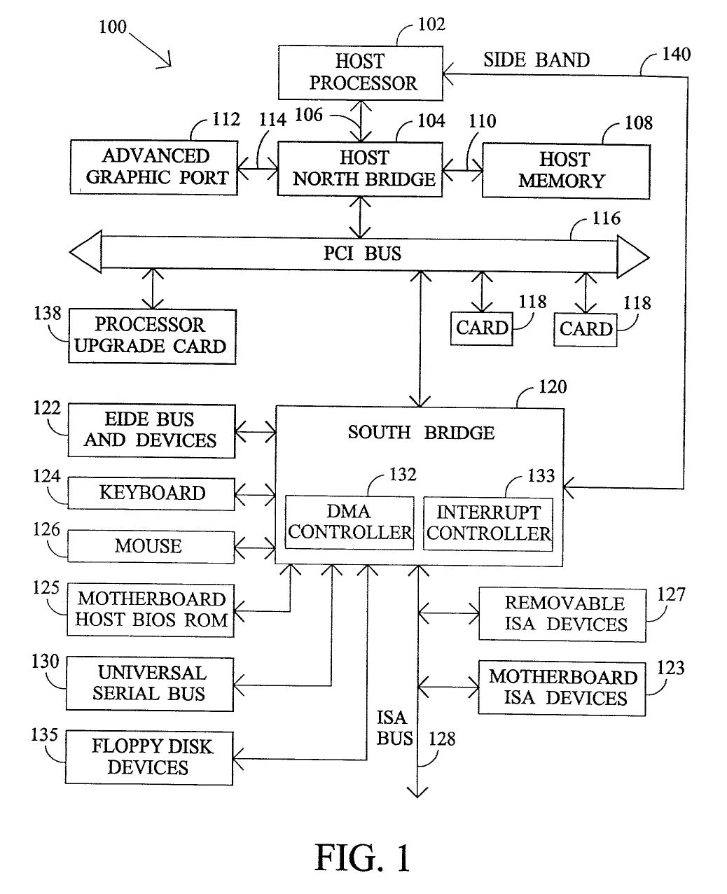

Referring to FIG. 1, an Intel compatible x86 based personal computer system 100 includes a host processor 102 which may include level 1 and level 2 cache. A host north bridge 104 is interconnected to the processor 102 with a bus 106. The bus 106 is typically operating between 50 and 100 MHz. The host north bridge 104 typically (1) acts as an interface which buffers queries, (2) includes a PCI controller and arbiter, and (3) provides cache and memory controllers. Host memory 108 is connected to the north bridge 104 with a bus 110 which is typically operating and frequently in excess of 200 MHz. between 50 and 100 MHz, and frequently in excess of 200 MHz. An advanced graphic port (AGP) 112 is connected to the host north bridge 104 with a bus 114 to provide a slot for a video card inserted therein to display images on a display device (not shown). The bus 114 is from the execution of a floating-point instruction. This signal is provided to allow the system logic to handle this exception in a manner consistent with IBM-compatible PC/AT systems.

IGNNE: IGNNE#, in conjunction with the numeric error bit in CR0, is used by the system logic to control the effect of an unmasked floating-point exception on a previous floating-point instruction during the execution of a floating-point instruction, MMX instruction, or the WAIT instruction.

A20M: A20M# is used to simulate the behavior of the 8086 when running in Real mode. The assertion of A20M# causes the processor to force bit 20 of the physical address to 0 prior to accessing the cache or driving out a memory bus cycle. The clearing of address bit 20 maps addresses that extend above the 8086 1-Mbyte limit to below 1 Mbyte.

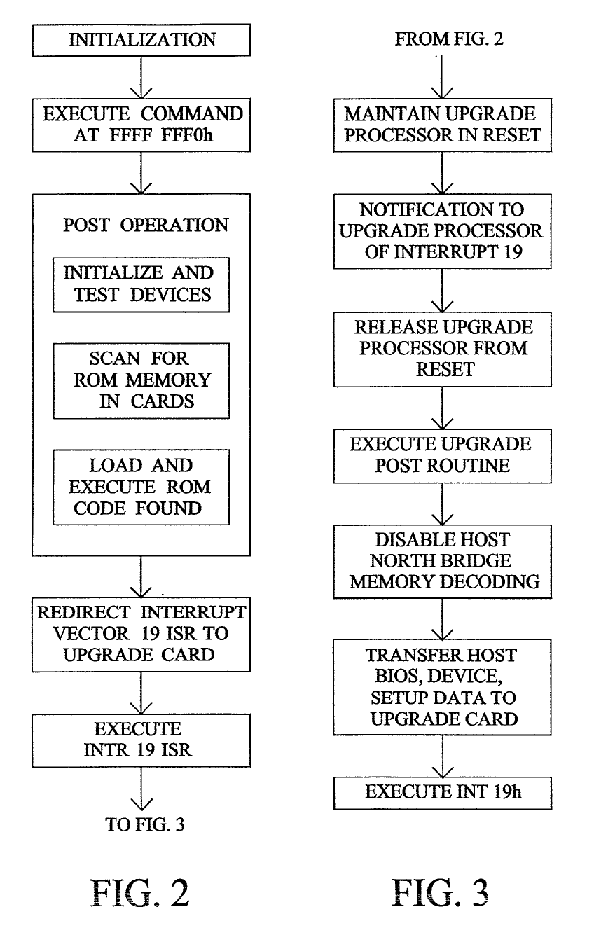

Also referring to FIG. 2, upon initialization of a computer system the processor executes instructions starting at FFFF FFF0h and the host computer system BIOS 125 performs a “POST” operation which is a “power on self test.” The POST initializes and tests computer system devices, such as the motherboard, the memory, attached devices, the video, the keyboard, the floppy drives, and the CD ROM. During the POST the computer system also scans for ROM memory in ISA and PCI cards/devices attached to the computer system, such as the ROM in the CD ROM, disk drive, video card, TV tuner card, sound card, or SCSI card. A copy of the ROM memory contents of attached PCI and ISA devices located during the POST operation will be copied into the host memory 108 and executed. After the POST operation the host processor 102 executes an interrupt 19h (INTR 19h) which results in the processor 102 executing interrupt service routine (ISR) code that causes the boot sector from the boot device, such as a hard drive, to be read into the host memory 108 and executed. This will start loading the particular operating system for the computer system.

The present inventors discovered that the interrupt 19h ISR can be used by the upgrade card 138 to gain control of the host system 100 if the interrupt vector 19h is intercepted and redirected to point to the ROM on the upgrade card 138. To intercept the interrupt vector 19h, the code within the upgrade ROM of the upgrade card 138 is loaded into memory 108 during the POST and executed, as with other expansion ROM devices. The upgrade ROM code loaded into the host memory 108 includes instructions that when executed redirects interrupt vector 19h to point to a portion of the copy of the upgrade ROM code within the host memory 108, as opposed to the normal boot code indicated by the host system BIOS 125. The portion of the upgrade ROM image within the host memory 108 which is now pointed to by the interrupt vector 19h, instructs the computer system 100 to access the upgrade card 138, and in particular the ROM on the upgrade card 138. This manner of redirecting the interrupt vector 19h after the POST operation allows the computer system 100 to start up in its traditional manner, without any conflict from the upgrade card 138. The change modifies the traditional start up just prior to loading the operating system. In this manner the computer system 100 starts up as normal, minimally affected (INT 19h revectored) by the upgrade card 138, which avoids configuration issues for the host motherboard and host motherboard BIOS.

For the sake of clarity to differentiate components supported by the upgrade card 138 and components of the computer system 100 prior to adding the upgrade card 138, the components supported by the upgrade card 138 will be referred to as “upgrade” while the components of the remaining computer system will be referred to as “host.” However, it is to be noted that the terms “upgrade” and “host” are merely for ease of identification.

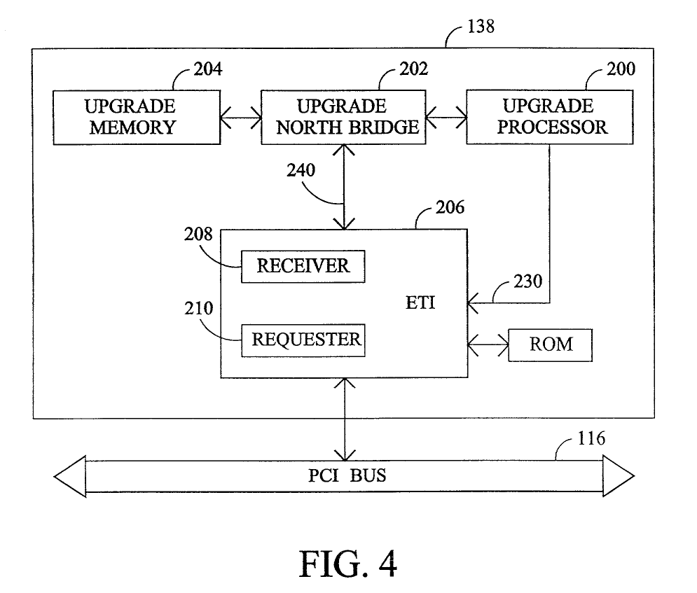

Also referring to FIGS. 3 and 4, the upgrade ROM code in the host memory 108 then notifies the upgrade card 138 of the execution of the interrupt 19h ISR so that the processor 200 on the upgrade card 138 can then start, referred to herein as the upgrade processor. Until typically operating at 66 MHz or 133 MHz. ISA and PCI based video cards are also common. The host north bridge 104 is interconnected to a PCI bus 116 which in turn provides access to PCI based add-on cards 118, 138 and a south bridge 120. The host north bridge 104 and south bridge 120 may be included within the same integrated circuit package, if desired. The PCI bus 116 is normally operating between 25 and 33 MHz. The south bridge 120 provides control over many device of the system, such as for example, EIDE bus and devices 122, a keyboard 124, a mouse 126, an ISA bus 128, motherboard ISA devices 123, removable ISA devices 127, motherboard host BIOS ROM 125, a DMA controller 132, an interrupt controller 133, floppy disk drives 135, and a USB 130. The south bridge 120 and associated devices provides what the consumer typically considers the “personal computer” functionality. The south bridge 120 and its associated devices operate relatively slowly in comparison to the host north bridge 104 and its associated devices. A set of side band signals 140 interconnect the south bridge 120 and the host processor 102.

The overall performance of the computer system is primarily determined by the host north bridge 104 and its associated devices, especially the host processor 102 and host memory 108. Existing processor upgrades use the existing processor socket, a proprietary processor bus, or specialized slots which have access to all of the signals available to the existing processor, including the side band signals 140. Current processor upgrades do not use a slot (or other interface) connected solely and directly to the PCI bus because it would have access to only the signals within the PCI bus 116. Accordingly, the side band signals 140 which directly interconnect the south bridge 120 and the host processor 102 are not available to such a PCI based card, which are needed by the host processor 102 to control the computer system 100 properly. While the lack of access to the side band signals 140 presents a substantial barrier to use of the PCI bus 116 to support a processor upgrade card, the present inventors discovered that a processor upgrade could be provided on an upgrade card 138 inserted into a PCI slot if the side band signals 140, which are not directly available, could be emulated, sensed, obtained, or predicted in some manner.

The side band signals 140 currently include the following ten signals within an Intel-compatible x86-based computer architecture:

RESET: When the processor samples RESET asserted, it immediately flushes and initialize all internal resources and its internal state including its pipelines and caches, the floating-point state, the MMX state, and all registers, and then the processor jumps to address FFFF_FFF0h to start instruction execution.

INIT: The assertion of INIT causes the processor to empty its pipelines, to initialize most of its internal state, and to branch to address FFFF_FFF0h—the same instruction execution starting point used after RESET. Unlike RESET, the processor preserves the contents of its caches, the floating-point state, the MMX state, Model-Specific Registers, and CD and NW bits of the CR0 register, and other specific internal resources.

FLUSH: In response to sampling FLUSH# asserted, the processor writes back any data cache lines that are in the modified state, invalidates all lines in the instruction and data caches, and then executes a flush acknowledge special cycle.

NMI: When NMI is sampled asserted, the processor jumps to the interrupt service routine defined by interrupt number 02h. Unlike the INTR signal, software cannot mask the effect of NMI if it is sampled asserted by the processor. However, NMI is temporarily masked upon entering System Management Mode. In addition, an interrupt acknowledge cycle is not executed because the interrupt number is predefined.

SMI: The assertion of SMI# causes the processor to enter System Management Mode. Upon recognizing SMI# asserted, the processor performs the following actions, in the order shown:

1. Flushes its instruction pipelines.

2. Completes all pending and in-progress bus cycles.

3. Acknowledges the interrupt by asserting SMIACT# after sampling EWBE# asserted.

4. Saves the internal processor state in SMM memory.

5. Disables interrupts by clearing the interrupt flag in EFLAGS and disables NMI interrupts.

6. Jumps to the entry point of the SMM service routine at the SMM base physical address which defaults to 0003_{—}8000h in SMM memory.

INTR: INTR is the system's maskable interrupt input to the processor. When the processor samples and recognizes INTR asserted, the processor executes a pair of interrupt acknowledge bus cycles and then jumps to the interrupt service routine specified by the interrupt number that was returned during the interrupt acknowledge sequence. The processor only recognizes INTR if the interrupt flag (in the EFLAGS register equals 1.

STPCLK: The assertion of STPCLK# causes the processor to enter the Stop Grant state, during which the processor's internal clock is stopped. From the Stop Grant state, the processor can subsequently transition to the Stop Clock state, in which the bus clock CLK is stopped. Upon recognizing STPCLK#, the processor performs the following actions, in the order shown:

1. Flushes its instruction pipelines.

2. Completes all pending and in-progress bus cycles.

3. Acknowledges the STPCLK# assertion by executing a Stop Grant special bus cycle.

4. Stops its internal clock after BRDY# of the Stop Grant special bus cycle is sampled asserted and after EWBE# is sampled asserted.

5. Enters the Stop Clock state if the system logic stops the bus clock CLK (optional).

FERR: The assertion of FERR# indicates the occurrence of an unmasked floating-point exception resulting notification that the interrupt 19h has occurred by the copy of the upgrade ROM in the host memory 108 being executed, the upgrade processor 200 on the upgrade card 138 is preferably maintained in reset mode. The upgrade processor 200 may alternatively be kept in a busy wait state. The upgrade ROM code in the host memory 108, upon execution of an interrupt 19h ISR, notifies the upgrade card 138 that the interrupt 19h has occurred. Upon notification of the interrupt 19h, the upgrade processor 200 on the upgrade card 138 is released from reset or a busy wait state. In this manner the upgrade processor 200 is started and then performs a set of activities, as if starting a traditional computer system in a manner akin to the host processor 102. However, many difficulties must be resolved because the host processor 102 is already operating and the desire is to operate an additional upgrade processor 200 in conjunction with the host processor 102, without any conflicts in the computer system 100 typically designed for a single processor.

The upgrade processor 200 then executes the reset vector FFFF FFF0h in the same manner as the host processor 102. The upgrade processor 200 and a upgrade north bridge 202 in the standard manner of execution would normally access the south bridge 120 through the PCI bus 116 for the POST operation, which is part of the computer system 100 prior to adding the upgrade card 138. The south bridge 120 would then access the host BIOS 125 in the same manner as previously accessed in response to the host processor 102. The host BIOS 125 is indifferent to the upgrade processor 200 and would, if allowed, start execution as normal. The host north bridge 104 on the motherboard and the upgrade north bridge 202 on the upgrade card 138 will likely include differences because the upgrade card 138 should include higher performance technology and provide support for additional features. With such likely differences in the north bridges, the host BIOS 125 will not properly configure the upgrade north bridge 202. The host BIOS in general would not know how to configure the upgrade north bridge. The host BIOS 125 will then misconfigure the computer system, possibly crashing the computer system 100. It is simply not acceptable to require the host north bridge 104 to match the upgrade north bridge 202 if increased system performance is desired. The present inventors discovered that this limitation can be overcome by including an additional chip (or additional circuitry or logic) on the upgrade card 138, referred to herein as an “ETI” circuit simply for matters of identification. The designation of “ETI” has no special significance other than a name for reference purposes. The reset vector of the upgrade processor 200 which branches to FFFF FFF0h is redirected to the upgrade ROM on the upgrade card which in turn addresses an upgrade BIOS routine within the upgrade ROM. With the reset vector of the upgrade processor 200 redirected to a location within the upgrade card 138, the south bridge 120 will not immediately be accessed upon reset in the traditional manner. Redirecting the upgrade reset vector to an upgrade BIOS routine permits the upgrade card 138 to include a separate BIOS routine.

The result of redirecting both the interrupt vector 19h ISR to the upgrade card 138 and the reset vector of the upgrade processor 200 to the upgrade BIOS routine is that the host processor 102 is executing POST BIOS extension code on the upgrade card 138. The upgrade processor 200 then executes a simplified upgrade POST routine for the upgrade card 138. The upgrade POST routine primarily initializes the upgrade north bridge 202, checks the upgrade memory size and configuration, and initializes and tests upgrade memory 204. The upgrade BIOS is not required to reconfigure any devices outside the upgrade card 138, but simply initializes the components on the upgrade card 138.

It is to he understood that the technique of performing a POST routine for a host computer system and then subsequently performing a POST routine for a separate upgrade processor independently of the host computer system can be employed for upgrade processors in general. In this manner, an upgrade processor and associated upgrade devices connected to the host computer system in any manner, such as a proprietary bus system, can be initialized and tested without interfering with the host computer system.

At this point the upgrade memory 204 is operational but the upgrade card 138 does not include configuration data of the host computer system nor any of the settings resulting from the host BIOS POST routine.

The operation of the host processor 102, and in particular the host north bridge 104, decodes memory addresses which are mapped to the host memory 108. Computer system activities such as direct-memory-access cycles and busmaster cycles normally are directed to the host memory 108. However, such memory accesses need to be redirected in some manner to the upgrade memory 204 on the upgrade card 138. Because Intel compatible x86 computer systems are designed to include only one north bridge circuit, and with the upgrade card 138 installed two north bridge circuit's exist within the computer system 100, the host memory 108 and the upgrade memory 204 include duplicate addresses. In other words, when executing software the host processor 102 through the host north bridge 104 will access the host memory 108 instead of the desired upgrade memory 204. Therefore to ensure that all memory accesses not originating from the host processor 102 are directed to the upgrade memory 204, the memory decoder enable bit for the host north bridge 104 is disabled by the upgrade host BIOS routine. It is important to disable the host north bridge memory decoding because the PCI bus specification does not support two devices decoding the same address on the PCI bus 116 at the same time. At this point the upgrade north bridge 202 within the computer system 100 is the only north bridge that decodes memory addresses from the PCI bus 116.

For the computer system 100 to operate properly the upgrade card 138 must obtain the resulting configuration information contained in the host memory 108, such as BIOS data tables, interrupt tables, device area (PCI devices found), and host BIOS. Unfortunately, disabling the memory decoder enable bit of the host north bridge 104 results in the upgrade processor 200 being unable to read from the host memory 108 because the host north bridge 104 will not decode any memory addresses coming from the PCI bus 116. In addition, a problem exists in that the location in memory of the configuration information has to be the same on the host and the upgrade. Therefore, the host north bridge would have to write to the same memory location on the upgrade as in the host memory. To overcome this limitation the present inventors further discovered that the upgrade ROM code in the host memory 108 should include a routine that instructs the host processor 102 to read the configuration (setup) information and write that information to the upgrade card 138. To write and address information at any address the memory decoding functions of the host north bridge first should be disabled so that other devices will access only the upgrade memory. To effectuate the memory transfer without using the host north bridge 104 memory decoder, which has been disabled, the present inventors further discovered that the PCI specification includes what is referred to as a “window space” which may be utilized to accomplish the task. The host processor 102 reads the host memory 108 for the configuration information and then writes the configuration information to the PCI “window space” reserved for the upgrade card 138. The upgrade card 138 receives, decodes, and writes the received configuration information to the upgrade memory 204 at the original addresses in the host memory 108. In this manner the configuration information (setup data) is transferred from the host memory 108 to the upgrade memory 204, after disabling the memory decoding functions of the host north bridge 104, so the resulting original configuration information is obtained by the upgrade card 138. This also alleviates compatibility issues because the upgrade card 138 has available the configuration information of the host computer system. For example, having the hardware configuration information resulting from the host POST allows the operating system and programs to operate properly. It is difficult to otherwise obtain such configuration information because registers in several chips may have changed.

Alternatively, the transfer of the configuration information may be accomplished using other techniques. Some suitable techniques include the use of registers, or memory transfers. In addition, the transfer of the configuration information may be done with the memory decoder of the host north bridge 104 enabled.

It is to be understood that the technique of transferring the configuration information to an upgrade processor and upgrade memory can be employed for upgrade processors in general. In this manner, an upgrade processor and upgrade memory connected to the host computer system in any manner, such as a proprietary bus system, can be matched to the host computer system which alleviates compatibility issues.

The host north bridge 104 and the upgrade north bridge 202 both include an arbiter which arbitrates the use of the PCI bus 116 between different devices. However, the PCI specification did not envision the possibility of two north bridges, and hence two arbiters, both of which are attempting to control the operation of the same PCI bus 116. The PCI bus specification includes provisions for only one arbiter, where the “requester” (initiator) is the device requesting access to the PCI bus 116 and the “grantor” is the arbiter. Unfortunately, unlike the memory decoder, the arbiter in existing host north bridges 104 can not be turned off and permit bus access requests to be serviced by the upgrade north bridge arbiter. While the host or upgrade north bridge could be designed to include the capability of turning off the arbiter thereby causing the north bridge to request PCI bus 116 access like other PCI based devices (enable the use of an external arbiter), it apparently was not previously considered a function that would have any application.

Referring to FIG. 4, to permit two north bridge circuits to access the same PCI bus 116, the ETI circuit 206 is interposed between the upgrade north bridge 202 and the PCI bus 116. The ETI circuit 206 includes a receiver 208 that receives bus access requests from the upgrade north bridge 202. Upgrade processor 200 local memory accesses are directed by the upgrade north bridge 202 to upgrade memory 204. Upgrade processor 200 non-local memory accesses (memory addresses outside the range of the upgrade card memory 204) are routed by the upgrade north bridge 202 to the receiver 208 in the ETI circuit 206. These non-local memory access requests are forwarded through the requester 210 in the ETI circuit 206 to the host PCI bus 116 in the same manner as any standard PCI card added to the computer system 100.

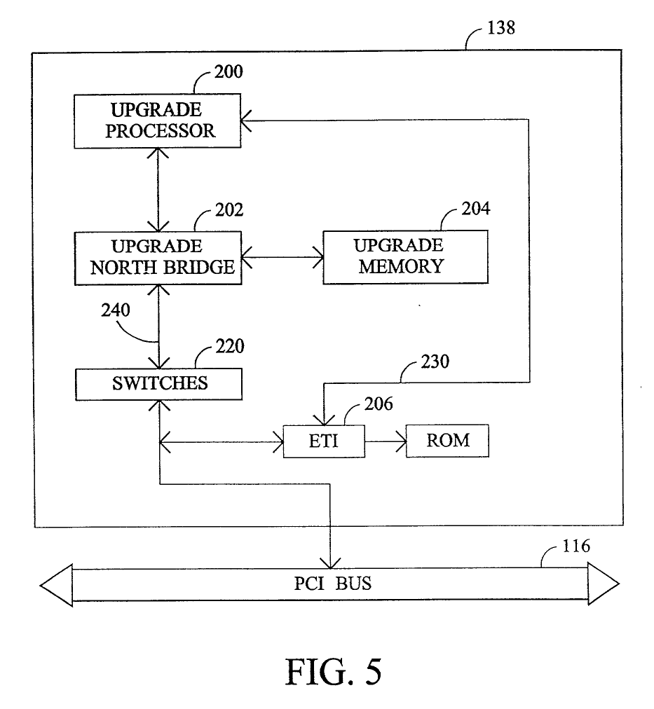

Referring to FIG. 5, in the event that the upgrade north bridge 202 includes a way to turn off its PCI bus arbiter or does not include an arbiter, then the ETI circuit 206 can be located in an alternative location, which reduces the complexity of the ETI circuit 206. A set of bidirectional on/off switches 220 interconnect the upgrade north bridge 202 to the PCI bus 116. The preferred switches are generally known as “quick switches.” The ETI circuit 206 is connected to the interface between the PCI bus 116 and the switches 220. Using this configuration the upgrade card 138 must predict the occurrence of events where data is to be transferred between the PCI bus 116 and the upgrade north bridge 202.

From the release of the reset on the upgrade processor 200 until the initialization is done, and from host IACK cycle to upgrade IACK cycle, the ETI circuit monitors the activity on the PCI bus 116. The 1 Meg address space FFFx xxxx includes the address space where all of the upgrade code is located. Addresses that start with FFF are stopped by the switches 220 and the ETI circuit 206 generates those addresses. The FFF is replaced by the window address space of the PCI bus 116 assigned to the upgrade card 138 by the computer system 100, such as FFE. Unfortunately, when a PCI cycle occurs it is too late for the upgrade card 138 to turn off the switches 220 in time. Accordingly, the possibility that a PCI bus cycle may start on the next clock edge must be predicted. The present inventors discovered that the PCI specification specifies that a cycle can commence when both (1) the grant is asserted and (2) the bus is idle. When these conditions are present, the addresses of FFF are converted to the PCI address space.

At this point the upgrade card 138 has the upgrade north bridge and memory system initialized and the memory 108 of the host system is copied to the upgrade card 138. Accordingly, the host processor environment has been effectively cloned into the upgrade processor environment. In either the configurations of FIG. 4 or FIG. 5, the present inventors have determined that while the contents of the memory have been copied, the attributes of the memory access must also be cloned in some manner. A portion of the upgrade memory 204 (640K to 1 Meg) includes attributes for each 16K, namely, R (read)/W (write)/C (cache).

In the case that read is off, write is off, and cache is off then addresses from the processor go to the PCI bus and reach the destination device.

In the case that read is on and write is off then addresses are read from memory and written to the PCI bus.

In the case that read is off and write is on, then addresses are read from the PCI bus and written to memory.

In the case that read is on and write is on, then addresses are read and written to memory.

The cache on/off controls whether or not reads can be temporarily stored in cache.

The purpose of the R/W/C attributes is to speed up ROM code accesses because ROM devices are usually slow in comparison to system memory, typically on the order of 100X. The slower ROM device is effectively mapped into fast memory to increase performance, otherwise known as shadowing. In addition, the image in memory is not always an identical copy of the ROM because the data may be compressed/encrypted and decompressed/decrypted by the processor when being transferred to system memory.

The memory attributes are not part of the PCI specification and are unique to each north bridge circuit design, being contained in registers therein. One potential solution is to program the ETI circuit 206 with the configuration information of each north bridge available. The upgrade card 138 would then identify the host north bridge 104 and reprogram the upgrade north bridge 202 to the same memory attributes. Unfortunately, the ETI circuit 206 would need to be periodically updated to support new north bridge devices. However, the memory attributes for each north bridge tend to change for the same chip and are not announced by the vendor, the attributes are not readily available, and the required attribute data for all possible north bridges would be substantial. An alternative solution is for the upgrade card 138 to observe the operation of the host north bridge when it performs a memory access. For each 16K of memory from 640K to 1 Meg the upgrade card 138 observes whether the read access goes to the PCI bus 116 or not, and whether the write access goes to the PCI bus 116 or not. The 0000 0000 address is always cached so the upgrade card 138 compares the performance of each 16K block of memory against the 0000 0000 address to determine which 16K blocks are cached. This will provide the R/W/C settings for each 16K memory block. The determination of the R/W/C settings is preferably performed by the upgrade BIOS routine.

It is to be understood that the technique of transferring the R/W/C setting of the memory attributes from the host north bridge to an upgrade north bridge can be employed in general. In this manner, an upgrade processor and upgrade memory including a decoder can be connected to the host computer system in any manner, such as a proprietary bus system, to match system memory performance requirements.

After obtaining the R/W/C settings and setting the upgrade north bridge 202 to match, the host configuration has been copied to the upgrade and 138. The upgrade card 138 is essentially brought to the same point of configuration as the host computer system prior to redirecting the interrupt vector 19h ISR to the upgrade card 138. The upgrade card 138 now executes an INT 19h ISR that results in the boot device loading the operating system.

With the upgrade card 138 operational and capable of running software the issue of the side band signals 140 which are not directly available to the upgrade processor 200 must be resolved in some manner, if possible, for proper operation. Unfortunately, the interrupt pin and other side band signals 140 of the host processor 102 are directly connected to the south bridge 120 so the upgrade processor 200 on a PCI based upgrade card 138 can not directly sense the assertion of the interrupt pin because it is one of the signals within the side band 140 which is not included within the PCI bus 116. Without sensing the assertion of the interrupt pin the upgrade card 138 is unable to control the operation of system devices. Upon the assertion of an interrupt by a system device, such as a device on the ISA bus, the interrupt line to the host processor 102 is asserted by the host interrupt controller 133, typically located in the south bridge 120. The host processor completes its current cycle and performs an interrupt acknowledge (IACK) bus cycle, which is a cycle that passes through the host north bridge to the system interrupt controller 133. The IACK cycle causes an in-service bit to be set within the interrupt controller 133 and an 8-bit vector to be read from the interrupt controller 133. The host processor 102 adds two 00 bits to the end of the 8-bit vector and uses that value to read an interrupt vector (4 bytes) from an interrupt vector table. The interrupt vector instructs the host processor 102 of the location of the first instruction in the interrupt service routine (ISR) for the particular asserted interrupt. The interrupt service routine then services the device that asserted the interrupt. After servicing the device an end of interrupt (EOI) command is executed which undoes the IACK effects within the interrupt controller 133 by unlocking the in-service bit within the interrupt controller 133 and the service routine is exited. Unfortunately, the setting and clearing of the in-service bit is a destructive operation which changes the 8-bit vector making it unreadable by another device, such as the upgrade processor. In addition, the destructive nature of the in-service bit read makes repeating the process to determine what interrupt was asserted not possible.

Referring again to FIG. 4, the present inventors discovered that this destructive read of the in-service bit of the 8-bit vector which makes the original vector thereafter unreadable can be circumvented by the upgrade card 138 monitoring the PCI bus 116. As previously described, the interrupt controller 133 receives an interrupt and in turn asserts the INTR signal to the host processor on the side band 140. The host processor 102 then performs an IACK cycle through the host north bridge 104 to the south bridge 120. The south bridge 120 then returns the interrupt vector to the host processor 102 and sets the in-service bit. The present inventors discovered that the interrupt vector returned to the host processor is actually passed to the host processor using the PCI bus 116 through the host north bridge 104, which may be used to solve this dilemma. The ETI circuit 206 monitors the signals on the PCI bus 116 and when an interrupt vector is placed on the PCI bus 116, the ETI circuit 206 also makes a copy of the interrupt vector. At this point the upgrade processor 200 must perform the same operations that were performed by the host processor 102 for proper computer system operation. The ETI circuit 206 asserts the INTR line to the upgrade processor through a set of side band signals 230 on the upgrade card 138. The upgrade processor 200 then performs the IACK bus cycles. The ETI circuit 206 receives the IACK bus cycles preventing the bus cycles from actually reaching the PCI bus 116. The ETI circuit 206 then provides the previously obtained interrupt vector from the PCI bus 116 to the upgrade processor 200. The upgrade processor 200 then executes the service routine pointed to by the interrupt vector provided by the ETI circuit 206. The service routine is executed and the INTR line in the south bridge 120 is deasserted. Normally, the interrupt service routines of the host processor 102 would be executed because the interrupt vector on the PCI bus 116 is actually received by the host north bridge 104. However, the upgrade ROM copied to the host memory 108 during the host POST replaces all the interrupt service routines with alternate routines that simply either wait until the ISR is executed by the upgrade card 138 or do nothing but a IRET. Any necessary ISRs are copied to the upgrade card 138 or loaded by the operating system (or device) into the upgrade memory 204.

The present inventors also discovered that the unavailability of side band interrupt signals can be observed, albeit indirectly, in the case of the ETI circuit being located as shown in FIG. 5.

An alternative technique of obtaining the interrupt vector does not involve the ETI circuit 206 monitoring the PCI bus 116. In response to an interrupt, the host processor performs an IACK cycle which gets a vector number from the south bridge 120 to the host processor 102. The host processor 102 obtains a pointer which directs it to an interrupt routine in the host memory 108. The interrupt routine then writes the vector number obtained by the host processor 102 through the PCI bus 116 to registers within the ETI circuit 206. The ETI circuit 206 then passes that vector to the upgrade processor 200 for execution of the appropriate interrupt routine from the upgrade memory 204.

The present inventors discovered that many operating systems during booting require the configuration value indicated by the CMOS battery backed RAM of the host memory 118 size must match the actual memory size detected by the operating system. When the host processor 102 and host memory 108 is accessed the CMOS must include a configuration value that matches the host memory size. Therefore, the configuration value of the upgrade memory 204 on the upgrade card 138 must match the upgrade memory 108. However, with the addition of the upgrade card 138 the operating system actually loads into the upgrade card 138 which results in a compatibility issue because the host memory configuration value likely does not match the upgrade memory configuration value, possibly resulting in a system crash. The present inventors discovered that the CMOS location that the operating system reads to obtain the host memory size can be virtualized. During the host POST operation the host processor 102 writes a value to I/O location 70, which is a pointer into CMOS RAM, of a value indicative of the memory size. The write to I/O location 70 is passed through the PCI bus 116 to the south bridge 120. The upgrade card 138 during the host POST monitors the PCI bus for I/O writes to location 70 and obtains the value written. The upgrade card 138 then, during the loading of the operating system, monitors the PCI bus 116 for read operations from I/O location 71, which is one method the memory size value is obtained. If the value previously written to location 70 matches the memory size index then the upgrade card 138 generates a SMI signal to the upgrade processor 200. The SMI mode of the upgrade processor 200 interrupts the upgrade processor operation at the highest level. Previously, the memory size value was read into a CPU register. The upgrade processor then changes that value to match the memory size of the upgrade memory 204. The memory size value is changed to match the upgrade memory size so the operating system will not detect a memory size mismatch.

The keyboard controller's input and output ports within the south bridge 120 include additional lines that are used for other functions besides the keyboard and mouse interface. The keyboard controller output signals typically include an A20 GATE that is ISA specific and implemented on most x86 systems to maintain backward compatibility. Depending on the particular system, the A20 GATE may also be called PASS A20, FORCE A20, etc., all of which apply to the same function and signal. When inactive, A20 GATE inhibits the generation of address lines A20 during Real Mode operation making newer processors compatible with the segment wrap-around that occurs on 8086 and 8088 microprocessors. The present inventors discovered that most modern operating systems, such as Windows 3.1, Windows 95, Windows 98, and Windows NT, test the A20 function during the boot sequence to determine if it is working properly. To test A20, the operating system reads and writes to one or more of I/O locations 60 (keyboard controller), 64 (keyboard controller), and 92 within the south bridge 120.

The operating system writes to one or more of I/O locations 60, 64, and 92 which results in the assertion of the A20 signal of the side band signals 140. The assertion of A20 will be received by the host processor 102 but not the upgrade processor 200 because the upgrade processor 200 is not directly connected to the side band signals 140. To overcome this limitation the present inventors discovered that by monitoring the PCI bus 116 for a sequence of byte writes to one or more of ports 60, 64, and 92, both the use of or testing of A20 can be predicted. When the upgrade card 138 determines that A20 is being used or tested, then the ETI circuit 206 asserts the A20 signal of the side band signals 230 to the upgrade processor 200 on the upgrade card 138. This causes the operating system loaded on the upgrade card 138 to detect the assertion of A20, as it expects.

It is to be understood that the technique of emulating the assertion of A20 of the side band signals for a host computer system, so that software using or testing A20 operates correctly, can be employed for upgrade processors in general. In this manner, an upgrade processor and associated upgrade devices (if any) connected to the host computer system in any manner, such as a proprietary bus system, can operate effectively when the A20 signal is used.

The present inventors discovered that sometimes software masks (disables) the interrupt input of the upgrade processor. For example, initialization software of the PS2 mouse executing on the upgrade card 138 may temporarily disable the interrupt on the upgrade processor 200. Accordingly, the interrupt mask bit of the upgrade processor 200 may be set by the software executing on the upgrade card 138. The generation of an interrupt will be masked by the upgrade processor 200, which will not generate an IACK cycle. However, since the software is executing on the upgrade card 138, and not the host processor 102, the interrupt asserted from the south bridge 120 will be sensed by the host processor 102 which will generate one or more IACK bus cycles because the software can not set the interrupt mask bit of the host processor 102.

To overcome the limitation of masked interrupts, the present inventors discovered that the additional unwanted IACK cycle from the host processor 102 can be cleared by the upgrade card 138 detecting the situation that the undesired IACK cycle occurs. The present inventors further discovered that the undesired IACK cycle (which would not occur without the upgrade card 138) can be determined by the upgrade card 138 in the following manner. First, the upgrade card 138 detects on the PCI bus 116 an input/output read of port 60 (keyboard). Second, the upgrade card 138 determines if there is a pending keyboard interrupt on the upgrade card 138. Third, the upgrade card 138 removes the pending keyboard interrupt on the upgrade card 138 and issues an end-of-interrupt (EOI) to the interrupt controller 133 of the south bridge 120 to clear the unwanted interrupt.

It is to be understood that the technique of clearing unwanted IACK bus cycles of a host computer system that would not have normally occurred but for the existence of the upgrade processor can be employed for upgrade processors in general. In this manner, an upgrade processor connected to the host computer system in any manner, such as a proprietary bus system, can determine the occurrence of undesired IACK bus cycles and clear them, if necessary.

During the execution of software, floating point errors, such as underflows (numeric value to small) and overflows (numeric value to large) sometimes occur. When such an error condition occurs, the upgrade processor 200 asserts an FERR. The ETI circuit 206 receives the FERR. In response the ETI circuit 206 provides an interrupt request (INTR line) to the upgrade processor 200 and also asserts IGNNE to the upgrade processor 200. In response, the upgrade processor 200 generates an IACK cycle which is received by the ETI circuit 206. The ETI circuit 206 returns the appropriate vector number for INT 13h. The upgrade processor 200 executes the service routine from upgrade memory for INT 13h and when the interrupt service routine has completed servicing the interrupt it performs a write to I/O location F0 which clears interrupt 13h and IGNNE. In this manner, the upgrade card 138 handles the IGNNE and FERR side band signals.

The present inventors discovered that the FLUSH interrupt of the side band signals 140 is normally only implemented on early x86 compatible personal computers for use with floppy drive controllers. The assertion of the cache FLUSH signal of the side band signals 140 to the host processor 200 simply empties the cache to memory. The emulation of such an event is of no consequence to the upgrade card 138 and therefore the present inventors determined that FLUSH does not need to be emulated, unlike the other side band signals 140.

The host processor 102 and upgrade processor 200 include an interrupt request input within the side band signals referred to as the non-maskable interrupt (NMI) input. If the NMI input goes active, the processor must immediately service that interrupt request. The NMI signal is typically used to report serious or fatal hardware failures to the microprocessor. Rather than request the interrupt table entry from the interrupt controller, however, the processor automatically accesses entry two in the interrupt table. This entry is dedicated to the NMI interrupt. During the POST, the programmer writes the start address of the NMI interrupt service routine located in ROM memory into entry two of the interrupt table. There are typically three possible causes for an NMI. First, the system board RAM parity check. Second, a channel check. Third, a watchdog timer status.

To detect the occurrence of a NMI asserted on the side band signals 140 to the host processor 102, the present inventors discovered that the ROM code loaded into the host memory 108 and executed during the host POST should modify the NMI service routine in the host memory 108. The modified NMI service routine should write to the upgrade card 138, and in particular to a register in the ETI circuit 206, of the occurrence of a NMI interrupt. In other words, the NMI interrupt routine should be revectored to address the upgrade card 138. The ROM code loaded into the host memory 108 and executed has also previously copied the NMI service routine to the upgrade card 138. The upgrade card 138, in response to an indication that an NMI interrupt has occurred, executes the copy of the NMI interrupt service routine on the upgrade card 138.

It is to be understood that the technique of revectoring the NMI interrupt service routine from a host computer system to an upgrade processor and associated upgrade memory can be employed for upgrade processors in general. In this manner, an upgrade processor and associated upgrade devices connected to the host computer system in any manner, such as a proprietary bus system, can be used without interfering with the host computer system.

INIT is another one of the side band signals 140 that the upgrade card 138 must detect, or predict in some manner. INIT results in a processor and computer system shutdown and re-initialization. If the host computer system is re-initialized then it is desirable that the upgrade card 138 re-initializes in the same manner. INIT does not use a vector so the previously described technique of revectoring a service routine is not available. The present inventors discovered that the host processor INIT originates from two sources. The first source is the result of the host processor 102 sensing through the bus controller of the host north bridge 104 a shutdown bus cycle asserted on the PCI bus 116 from another device connected to the PCI bus 116. The second source is the software setting of registers in the south bridge 120 or the host north bridge 104 causing the computer system 100 to re-initialize. The south bridge 120 asserts the INIT line of the side band signals 140 for either of these sources of re-initialization requests. To determine when the host computer system 100 is going to reinitialize, the upgrade card 138 monitors the PCI bus 116. In particular, the upgrade card 138 re-initializes the upgrade processor 200 if the upgrade card 138 senses a shutdown cycle on the PCI bus 116. The upgrade card 138 also re-initializes the upgrade processor 200 if the upgrade card 138 senses a write to a register of either the host north bridge 104 or the south bridge 120 that would result in the host computer system being re-initialized.

The emulation of STPCLK is not absolutely necessary for the upgrade card 138 to operate in a desktop environment. In a computer system with limited power, such as a laptop, the emulation of STPCLK may assist in the upgrade card 138 realizing power savings. To determine if the host processor 102 has an asserted STPCLK input, the upgrade card 138, and in particular software loaded by the upgrade card 138 during the host POST into the host memory 108, performs performance measurement tests to determine if the STPCLK mode is active. If STPCLK mode is active then it is reported to the upgrade card 138, through the PCI window space, to activate STPCLK mode for the upgrade processor 200

The present inventors discovered that a potential exists with the addition of a second north bridge circuit that includes an arbiter for deadlocks of system resources. Deadlocks are possible when two or more devices are waiting for the same resource and have exclusive access to a portion of that resource, such as the PCI bus 116. The arbiter within the host north bridge 104 shares the PCI bus 116 among different devices in what is generally referred to as a “fair” manner. In such a manner, no device is denied access to the PCI bus 116 indefinitely by the arbiter within the host north bridge 104. The ISA bus requires a guaranteed access time (GAT) for ISA devices. In other words, requests from ISA devices to the south bridge 120 must be serviced by the PCI bus 116 and host north bridge, if necessary, within a specified amount of time. The GAT is not a requirement of the PCI bus 116 so the south bridge 120 requests the PCI bus 116 from the arbiter of the host north bridge 104 on a specialized input. The host north bridge 104 in response stops the host processor 102, flushes the internal buffers of the host north bridge 104, and provides access to the PCI bus 116 to the south bridge 120, all in an attempt to meet the GAT. At this point the ISA device has access to the host memory 108 and other devices. The dilemma that the inventors discovered regarding deadlocks is that the arbiter of the host north bridge 104 grants the PCI bus 116 to the south bridge 120 and refuses to grant the PCI bus 116 to any other device because of the GAT requirements of ISA based devices. In addition, the host memory 108 is not accessible from the PCI bus 116 because the host north bridge 104 has its memory decoding disabled.

The upgrade card 138 monitors the PCI bus 116 for accesses originating from ISA based devices, such as memory accesses, which are received and decoded by the ETI circuit 206. The upgrade north bridge 202 decodes the memory addresses and obtains the data from the upgrade memory 204. However, with the upgrade card 138 being unable to access the PCI bus 116 because the arbiter of the host north bridge 104 will not release the PCI bus 116, the upgrade card 138 can not respond to ISA bus devices through the PCI bus 116.

The buffers of the ETI circuit 206 which accept data from the PCI bus 116 and permit access to the upgrade card 138, and the buffers of the ETI circuit 206 which accept data from the upgrade processor 200 and request access to the PCI bus 116 may be full. In traditional computer systems with one north bridge there are a set of rules within the north bridge that alleviate potential deadlock situations. Because the computer system design included one north bridge controlling such arbitration rules, the north bridge will not break the arbitration and deadlock rules.

One potential solution is for the ETI circuit 206 to include an excessively large buffer size and permit passing of posted-memory-writes/delayed-read-completion/delayed-write-completion cycles. In this manner the ETI circuit 206 can provide the appropriate commands to the upgrade north bridge, in an out-of-order manner beyond the buffer size of the upgrade north bridge. Another potential solution is to predict delayed-read-requests from the south bridge 120. Direct memory access (DMA) controllers use fixed addresses so the ETI circuit 206 monitors the PCI bus 116 for DMA cycles and uses detection of these cycles as the basis to predict the memory needed. The ETI circuit 206 reads the needed values from the upgrade memory and stores the values in the ETI circuit 206. When the delayed-read-requests are received by the ETI circuit 206 the ETI circuit 206 services it internally. Therefore there is never a bus deadlock.

The present inventors discovered that many modern operating systems, such as Windows 95, Windows 98, and Windows NT, execute an interrupt 15h which accesses the computer system's memory map stored in system memory. However, merely copying this to the upgrade memory will not solve the problem of different memory sizes because the actual upgrade memory size will not likely match the host memory size, as indicated by the memory table. The present inventors solved this dilemma by copying the upgrade code and the memory table from the host memory to the upgrade card by copying memory locations in the range C0000h to FFFFFh, as previously described. The original upgrade interrupt 19h service routine in the host device memory area, which has been copied to the upgrade card, is replaced by an interrupt 15h service routine. The interrupt 15h service routine includes an appropriate memory map for the memory on the upgrade card 138. The TNT 15h vector is then redirected to the new interrupt 15h service routine. In addition, the normal INT 15h functions are preserved. When a program running on the upgrade card, such as the operating system, executes an INT 15h it will be serviced by the INT 15h service routine to provide the proper memory size, as opposed to the improper memory map located within the address range F0000h to FFFFFh generated as a result of the host BIOS. In addition, memory space in the range C0000h to EFFFFh was selected to store the service routine because it is not overwritten by the operating system.

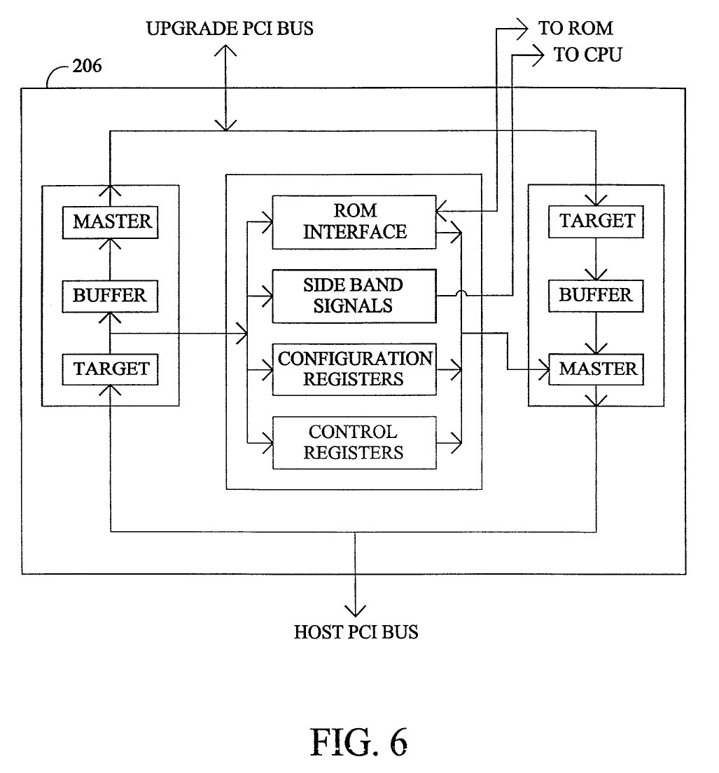

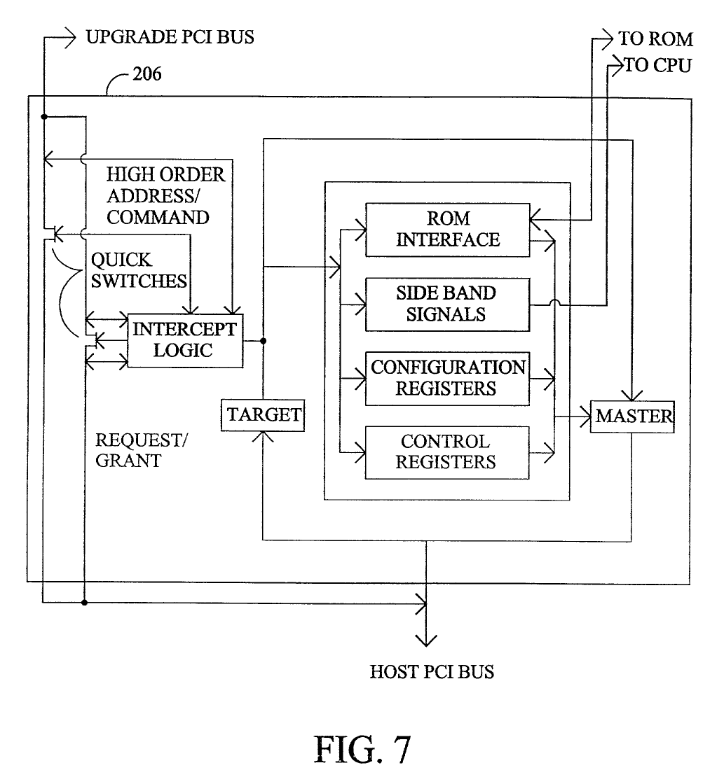

Referring to FIG. 6, the ETI circuit 206 (FPGA) suitable for use with FIG. 4 may be constructed as illustrated. The master circuits provide the respective initiator functionality for the host PCI bus and the upgrade PCI bus. The target circuits respond as appropriate to initiators on their respective PCI buses. Referring to FIG. 7, the ETI circuit 206 (FPGA) suitable for use with FIG. 5 may be constructed as illustrated.

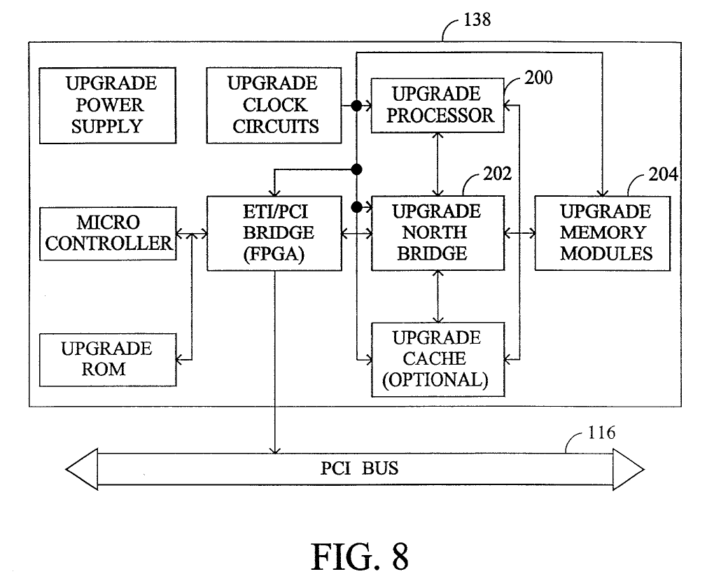

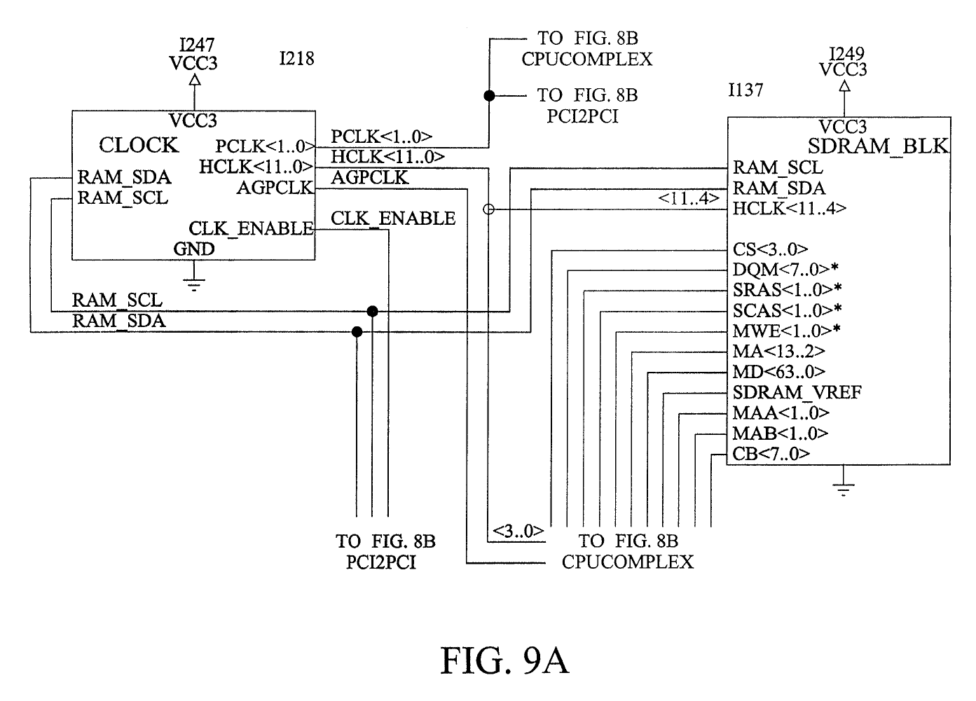

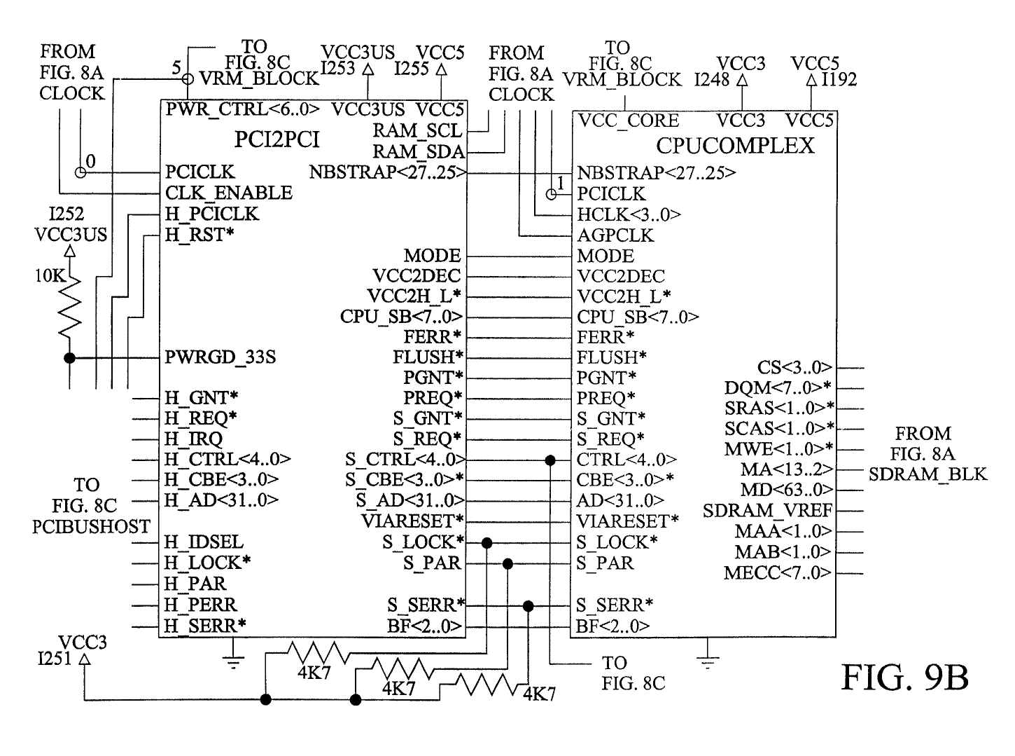

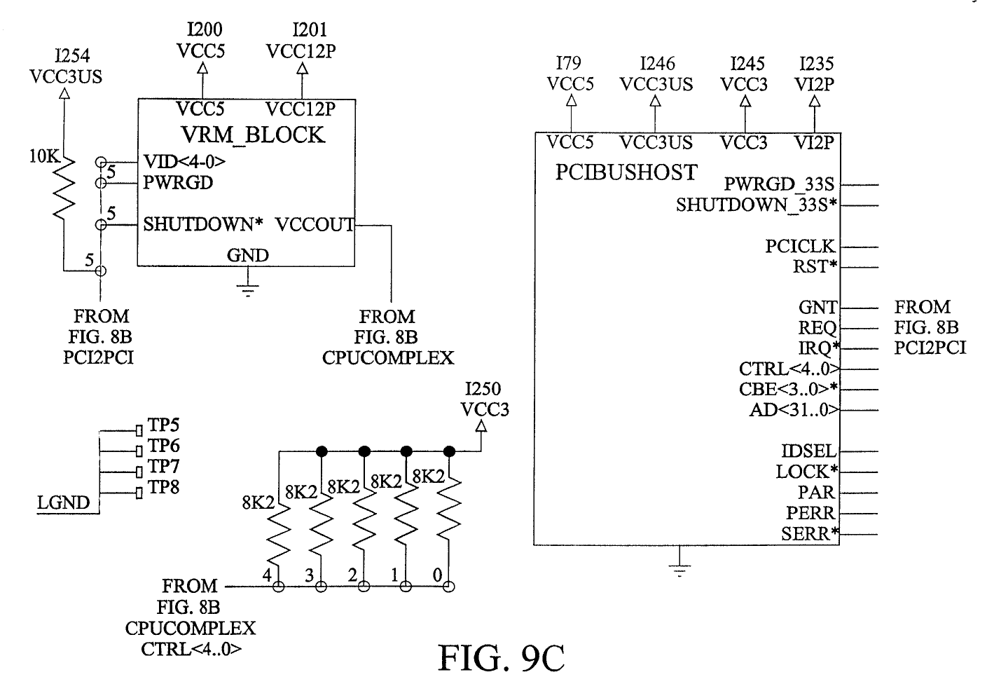

Referring to FIG. 8, for matters of illustration purposes a more detailed description of the software is provided that corresponds with the particular hardware implemention used. The micro controller configures the FPGA using code stored in the upgrade ROM. At this time the upgrade card 138 will respond to PCI configuration cycles and can be found during the normal host system PCI bus scan. During the host system PCI scan the upgrade card 138 will be two megabytes discovered by the host BIOS and allocated two megabytes of space somewhere in the 4 gigabyte memory space of the host PC. The ETI PCI configuration space registers conform to the PCI local bus specification (such as 2.1) and allow for all functional configuration of the upgrade card 138 including address relocation, interrupt mapping, and expansion ROM initialization. The configuration space registers also include the standard device Ids, class code, and revision identification registers. Once the host BIOS has relocated the upgrade card 138, the upgrade expansion ROM code is loaded into host memory 108 and the upgrade ROM initialization code is executed. The sole function of the initialization code is to revector INT 19h (system boot) and to save the PCI device location of the upgrade card 138 (Bus#, Device#, Function#) which was passed in by the host BIOS code at expansion ROM discovery time. After the initialization code has run the upgrade ROM BIOS loader code will be moved by the host BIOS to somewhere in the memory region occupied by add-on devices in the memory address range C0000h-EFFFFh. The upgrade BIOS code loader will occupy the minimum amount of device space allocated by the host BIOS (512 bytes or 2K bytes depending on the BIOS). After completion of the initialization of the upgrade card 138 the host BIOS completes its normal POST which includes device initialization for all onboard devices along with all other cards in the local buses in the host system. The upgrade card software in no way interferes with the normal host POST. All of the regular BIOS data tables and maps will be created and used later by the upgrade software at INT 19h time.

At INT 19h time control is transferred to the upgrade host code loader (via the upgrade address in the vector table inserted at device ROM initialization time). The upgrade host code loader uses the device address saved at initialization time to find the BIOS relocation address saved in PCI configuration register 10h to determine the location the upgrade ROM where the upgrade host kernel code is stored. The code is then moved by the upgrade host loader to low memory on the host system. On completion of the code move the loader gives up control and begins execution of the upgrade host kernel initialization in low memory. The initialization consists of installing the upgrade host runtime interrupt handlers and the upgrade host communications handler. Once the handlers have been installed the upgrade host code starts the upgrade card initialization by clearing the reset bit in byte one of the communication registers (description of registers to follow).

Once reset has been cleared by the upgrade host kernel (via communication register byte 1 bit 7 write) the upgrade processor begins execution at the regular x86 reset vector. The upgrade north bridge is initialized followed by upgrade memory discovery and initialization. Upgrade memory discovery and initialization in each of the memory module sockets is done through use of serial presence detect (SPD) The SPD code is compatible with Intel SPD specification 1.2A. After low memory (less than 1 megabyte) is tested the upgrade BIOS POST code is downloaded from the upgrade BIOS ROM to low memory where the following initializations are performed:

The upgrade card relocation address is found via a PCI bus scan and a read of configuration register 10h.

The communications are established with the host system.

The SMM space is loaded with the upgrade SMI handler and then locked. This is accomplished by register initialization in the upgrade north bridge followed by a code move into SMM memory. The SMI entry point, which is 38000h by default, is then redirected to the memory area at A8000h by forcing an SMI (via communications register byte 3 bit 2) and then adjusting the SMI entry register base address to A0000h.

The host systems original interrupt vectors along with the host BIOS data table created during POST are uploaded (address 0-500h). This is accomplished using a memory window in the PCI space occupied by the upgrade card.

The host system device area (C0000h-EFFFFh) is uploaded.

The host system runtime BIOS (F0000h-FFFFFh) is uploaded.

The upgrade extended memory is tested and the upgrade system memory map is generated. The map created is compatible with INT 15h function E820h. This map is used by the Microsoft Windows family of operating systems.

The device memory area that was uploaded is modified to include an INT 15h handler in place of the original upgrade INT 19h handler uploaded with the host device memory area. The new INT 15h handler and memory map occupy the same location as the original upgrade code in the device memory area (C0000h-EFFFFh) and maintains PCI compliance.

The original interrupt vector table that was uploaded has INT 15h is revectored to the upgrade interrupt 15h service routine stored in the device area.

On completion of the device initialization, host memory upload and interrupt modification the upgrade processor executes an INT 19h (system boot).

The upgrade host kernel consists of a small register based communications handler along with interrupt interrupts service routines for each of the 8 processor interrupts and 16 interrupt controller interrupts. The communications handler is used in the event the upgrade card needs some host system information during an SMI or under a controlled shutdown (CNTRL-ALT-DEL). The communications registers are used to pass the commands and data between the two processors and if necessary a memory window is opened on the upgrade card in the SMM region at A0000h to pass block data.

The interrupt service routines provide several important functions which are critical to the upgrade functionality.

Host processor IRET interface: During an interrupt cycle the host processor must have somewhere to execute code without running code in the BIOS. These routines do not service any of the device hardware. They provide the upgrade card a mechanism to work with any of the interrupts before the operating system is installed, if necessary.

In some special cases it becomes necessary to service both the hardware and the interrupt controller without passing the interrupt to the upgrade card. Although rare it is possible for the timing of events to be off enough to cause the operating system to fail to properly identify and initialize all system devices. The second function of the host board kernel is to communicate with the ETI bus controller 206 during the interrupt cycle to see if one of these special events has occurred. There are four possible interrupt states as seen by the ETI bus control logic. The register bit definitions describing the interrupt states are defined in the communications register summary below.

State 1—The bus control logic has seen the interrupt and passed it on to the upgrade processor. In this case the host processor executes an interrupt return with no other special action.

State 2—The bus control logic has detected a special condition and wishes the host processor to fully service the interrupt. The one currently defined special case occurs during PS2 mouse/keyboard initialization and requires a read of the keyboard port to service the device. The bus control logic generates the device read while the host interrupt handler cleans up the host interrupt controller by executing an EOI command and then an IRET to return to normal operation.

State 3—The bus control logic has detected multiple interrupts on the bus. In this case the host processor will execute an IRET and return to normal operation. The bus logic has buffered one and passed the other on to the upgrade processor.

State 4—The bus control logic has detected a single interrupt but has not yet been able to pass it on to the upgrade card. The host code will wait until the bus control logic sets the complete bit as in state 1 above. The normal sequence of operation would be a state 4 condition followed by a state 1. However, the bus control logic almost always detects and passes on the interrupt before the upgrade host kernel interrupt service routine is entered, and will almost always see state 1 on entry to the ISR.

Unlike the upgrade host kernel the upgrade BIOS code is used almost entirely for upgrade board initialization and configuration. On completion of upgrade POST there are only two pieces of code remaining active. The first is the INT 15h handler which is located in the device memory region between C0000h-EFFFFh. The second code block resides in the SMM space starting at address A8000h. This code is invisible to the operating system and provides a way for the host board to stop the upgrade processor execution and to service special conditions without the knowledge of the operating system.

The communication registers consist of 8 bytes accessible as memory locations at offset A0000h from the upgrade board PCI base address. As described earlier the base address is set by the host BIOS during POST. The register bit definitions are as follows:

BYTE 0 (RO) This is the last interrupt vector seen on the bus.

BYTE 1 (RW)—

Bit 0—Interrupt bit 0

Bit 1—Interrupt bit 1

10

00—Interrupt passing complete. Host executes IRET

01—Host executes EOI, IRET (effectively eats interrupt)

10—Multiple interrupts pending. Host executes IRET

11—Single interrupt pending. Host executes IRET.

BYTE 2 (RW)—

Bit 0—Request service from upgrade host kernel.

Bit 1—

Bit 2—Generate SMI.

Bit 7-3 Host master interrupt controller base I/O address.

BYTE 3 (RW)—

Bit 0—Host service complete.

Bit 1—Spare

Bit 2—Spare

Bit 7-3—Host board slave interrupt controller base I/O address.

BYTE 4 (RW)—General communications register (all 8 bits)

BYTE 5 (RW)—

Bit 0—SPD Clock (serial presence detect clock).

Bit 1—SPD Data.

Bit 2—Spare

Bit 3—Direction (I/O) of instruction which caused SMI

Bit 7-4—SMI byte enables (state of byte enables at SMI time)

BYTE 6 (RO)—

Bit 7-0—Address (7-0) of I/O which caused the SMI.

BYTE 7 (RO)—

Bit 7-0—Address (15-8) of I/O which caused the SMI.

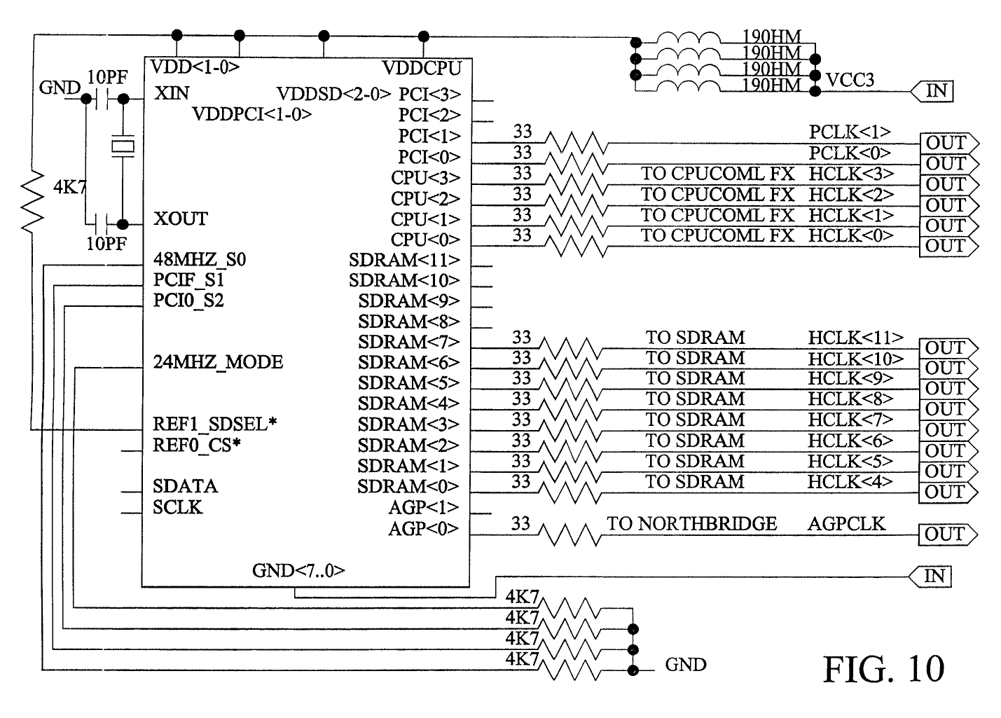

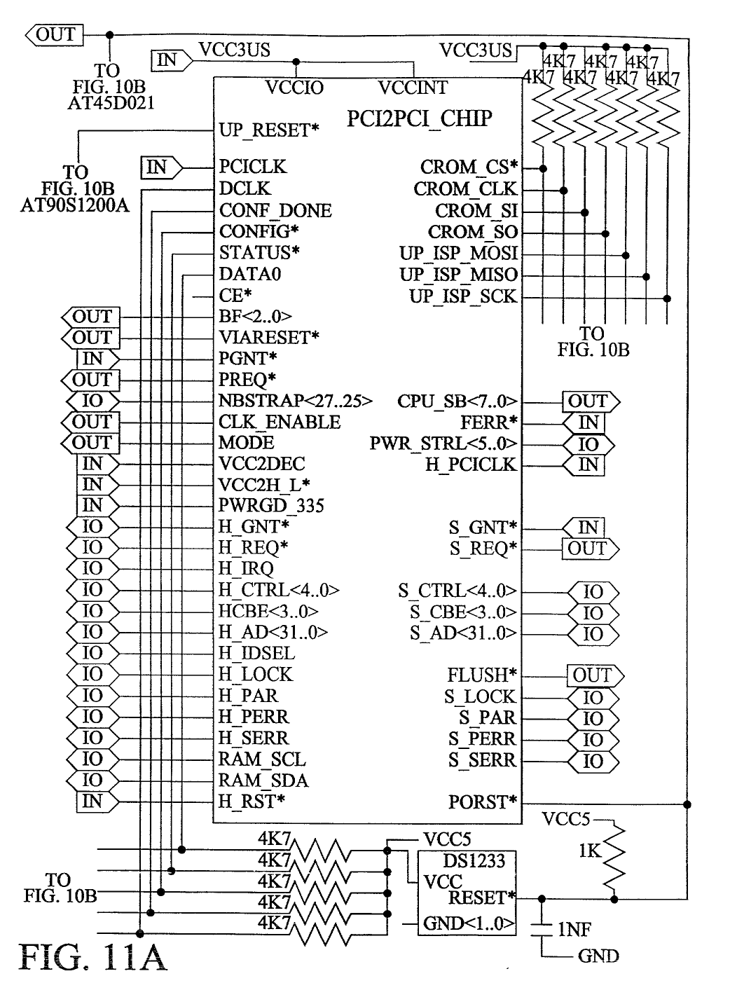

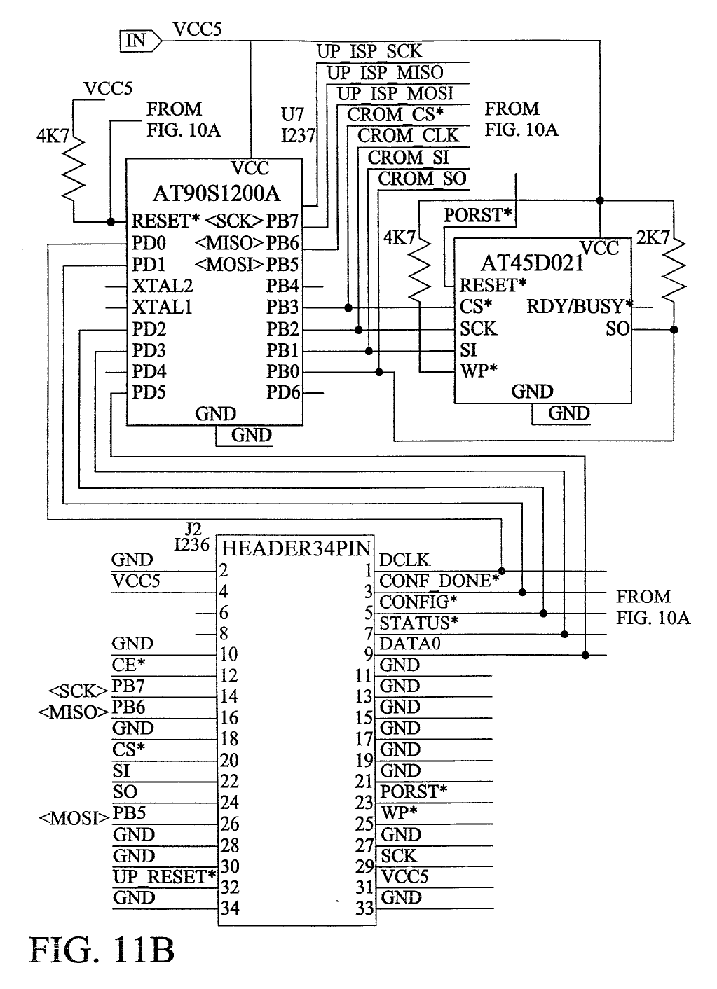

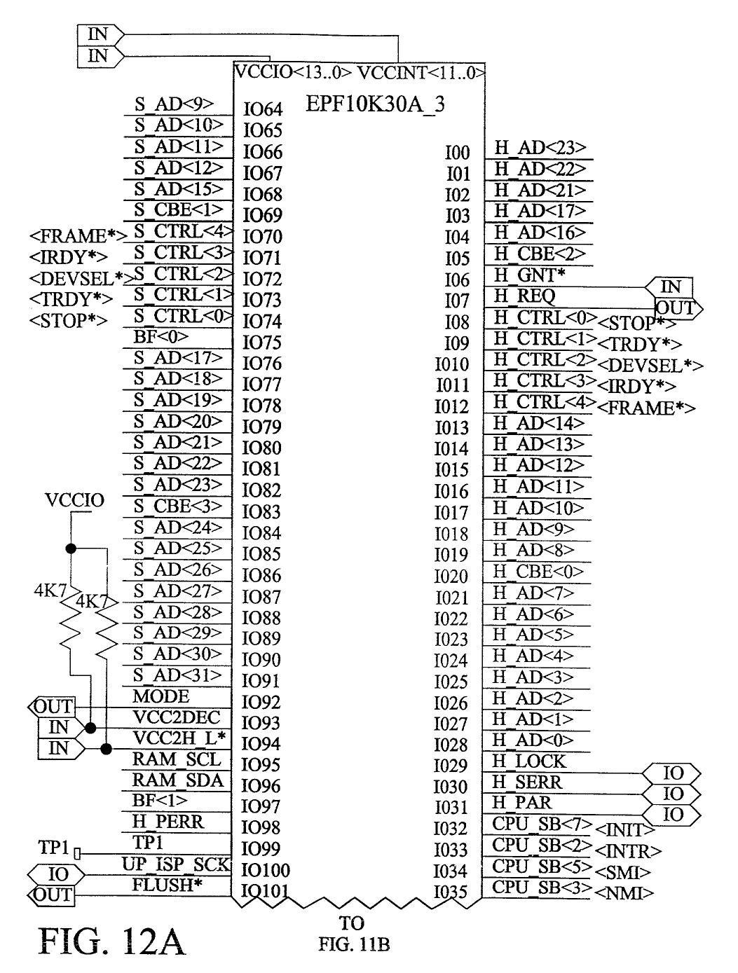

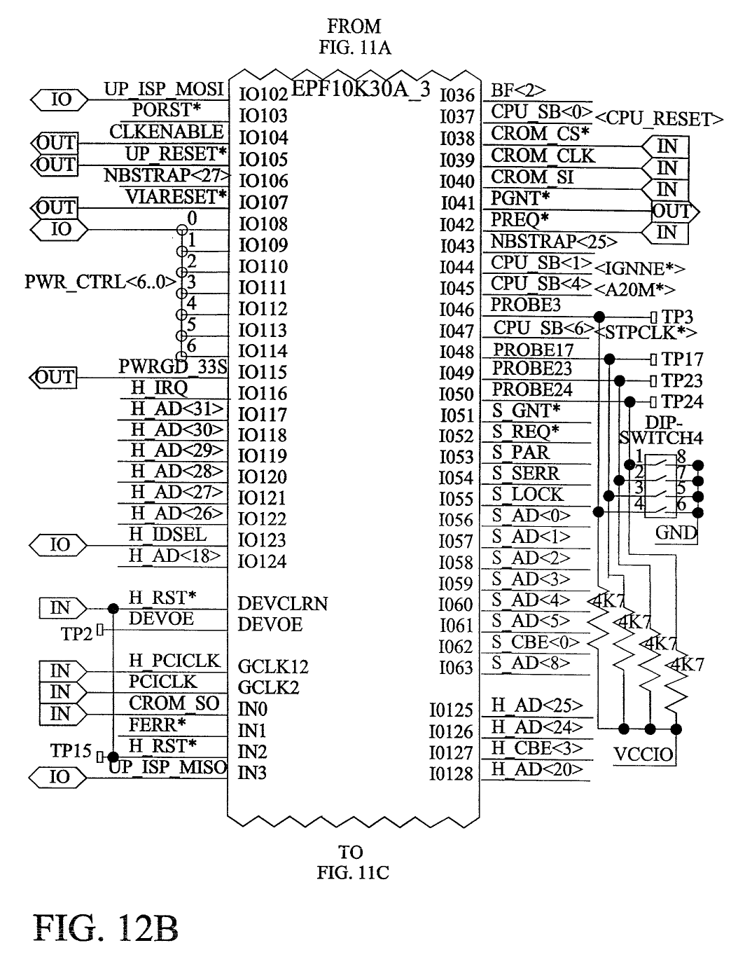

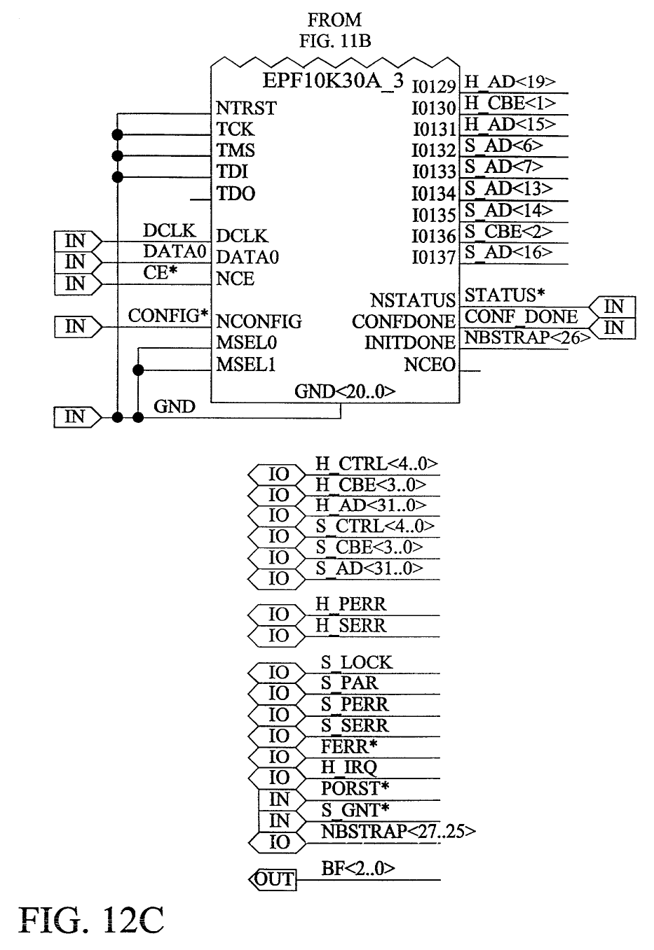

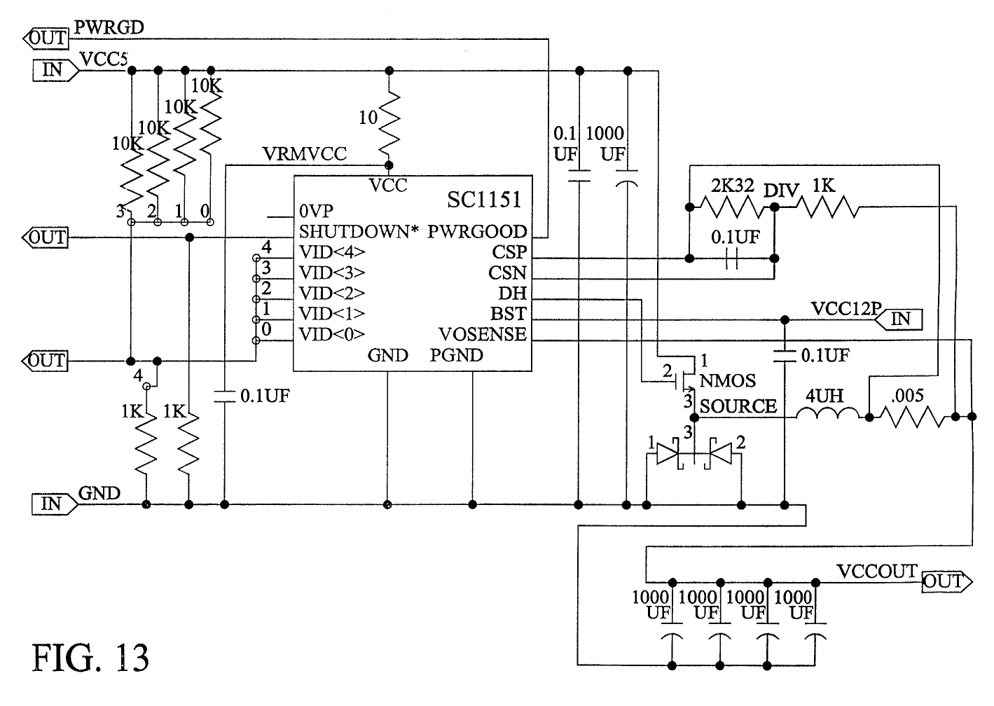

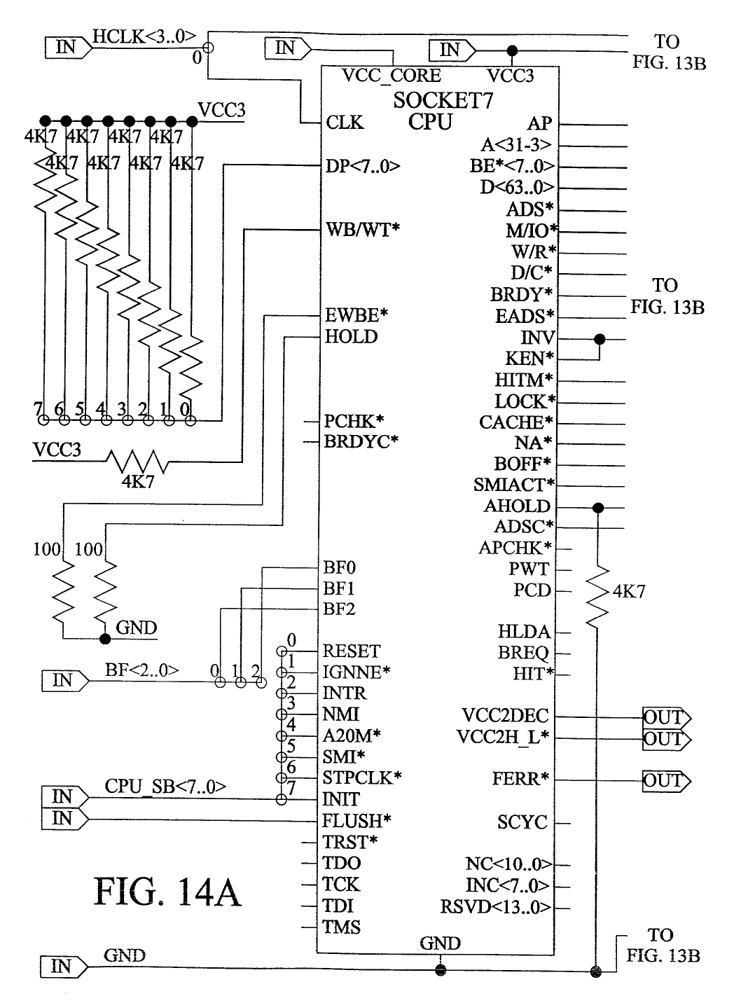

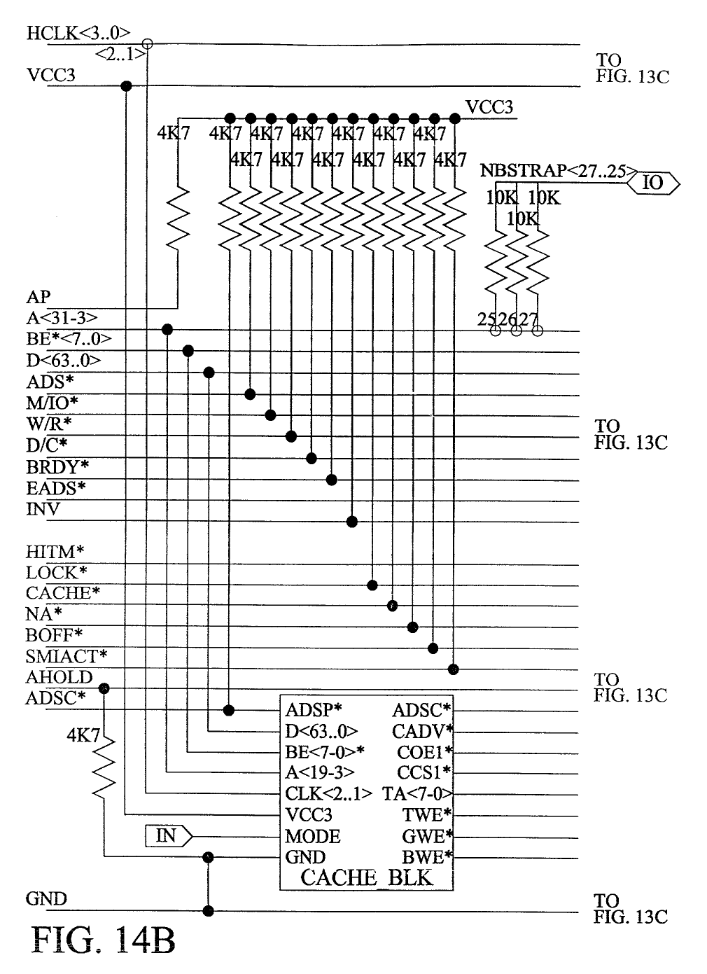

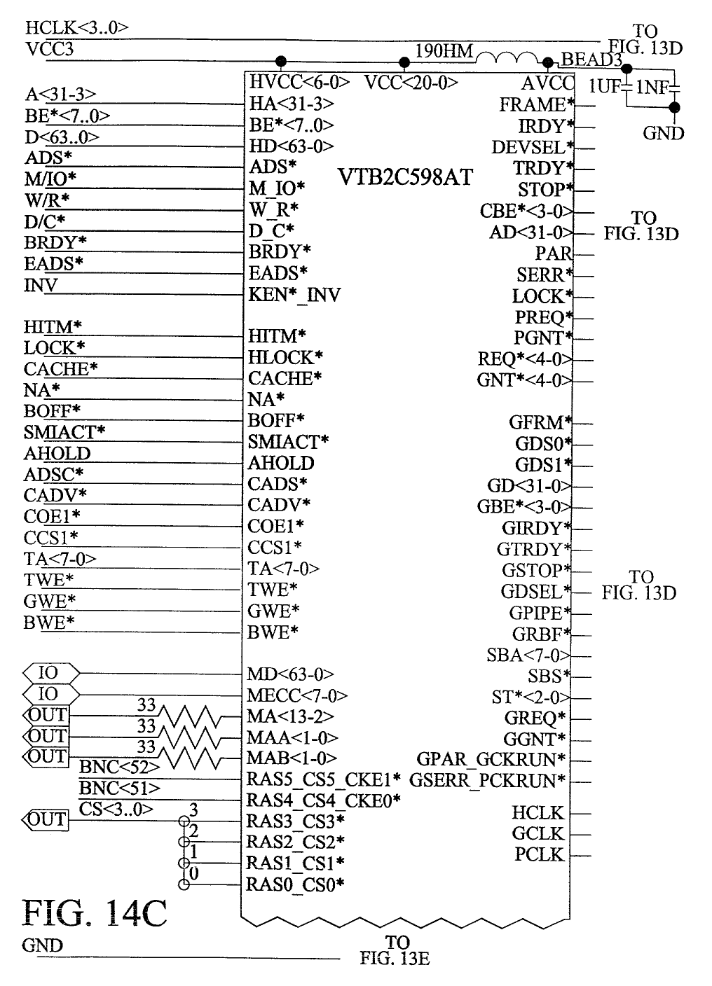

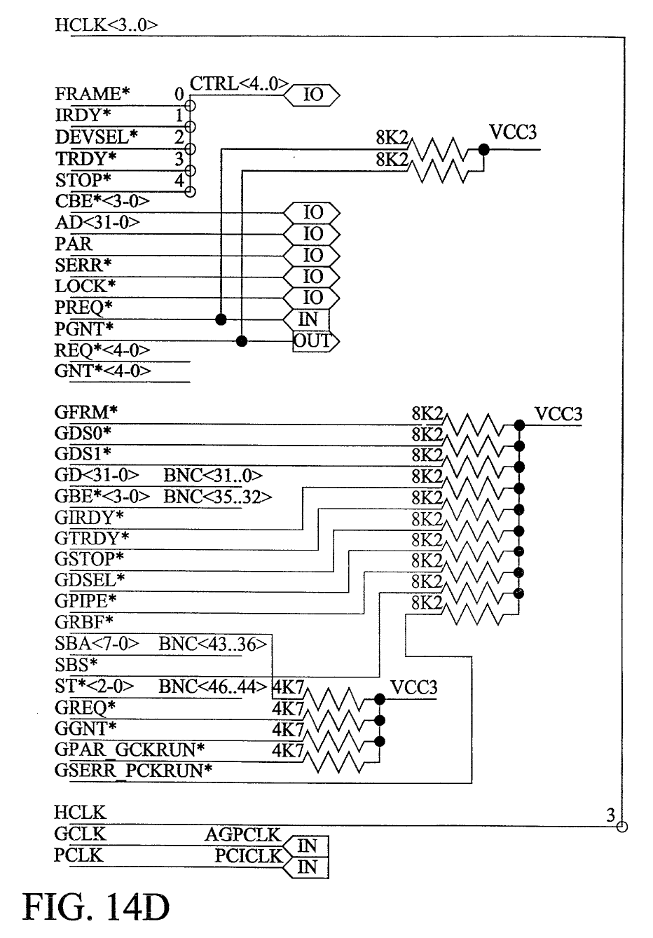

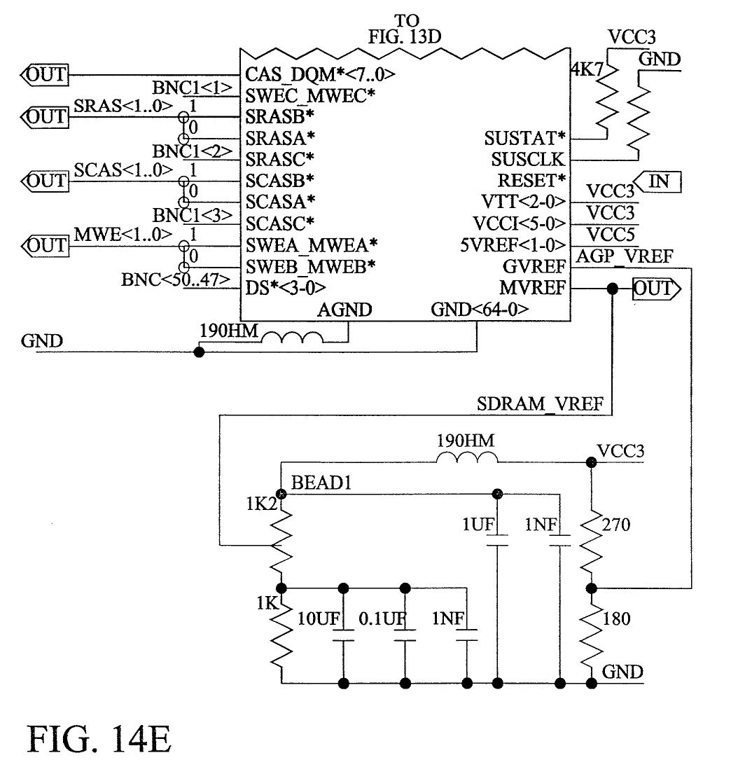

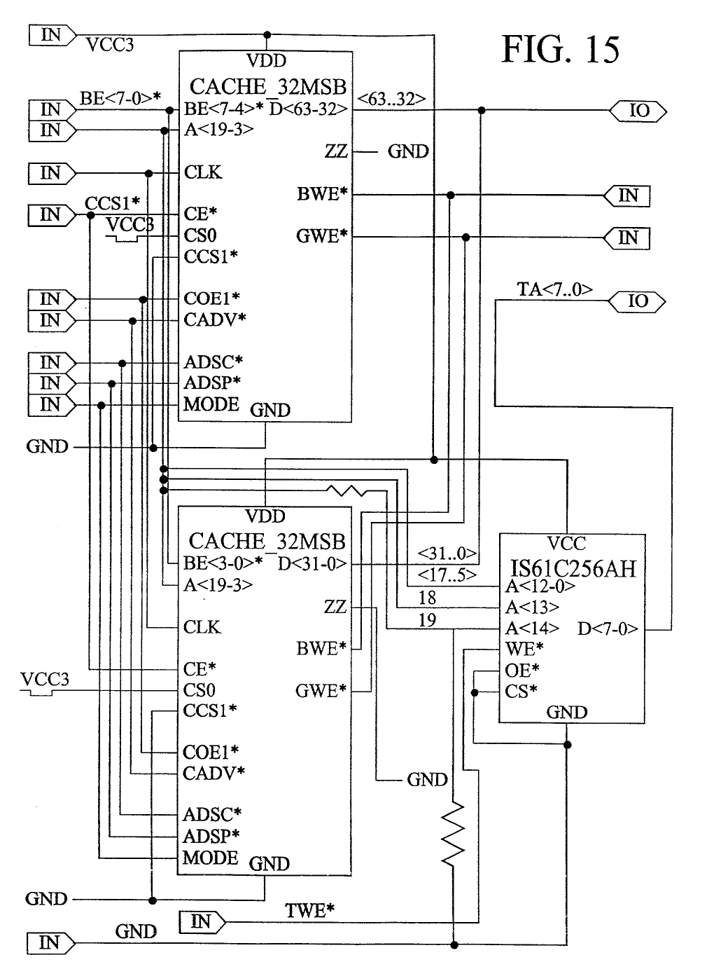

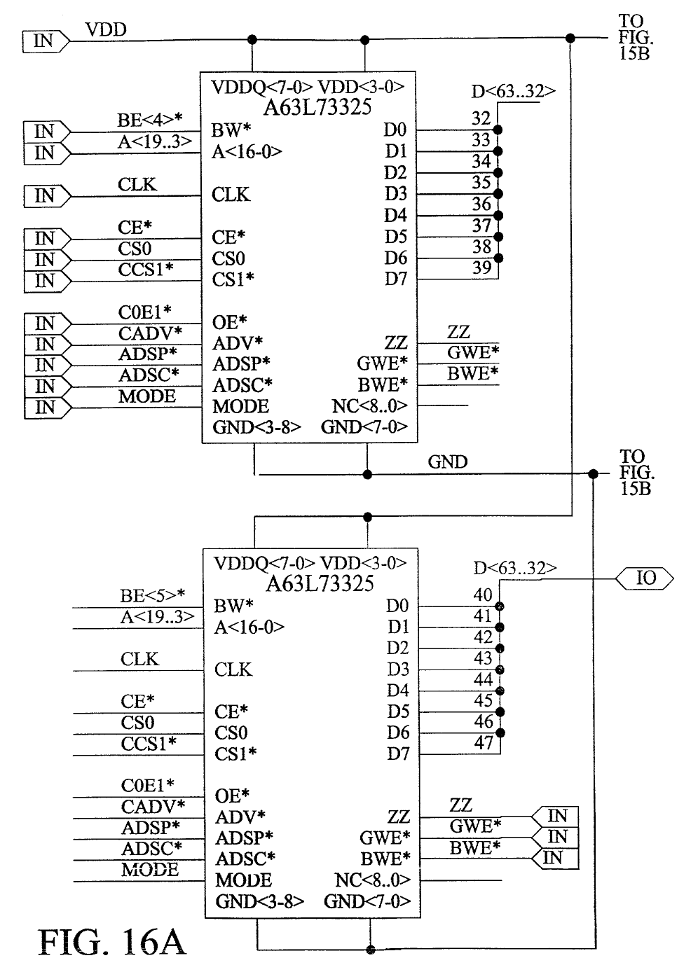

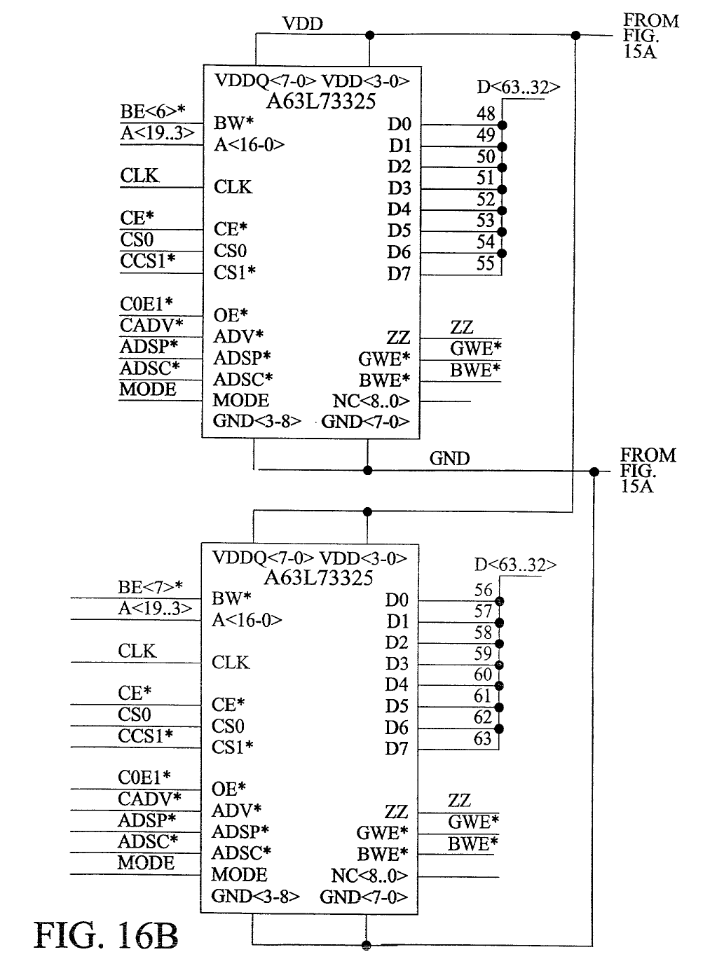

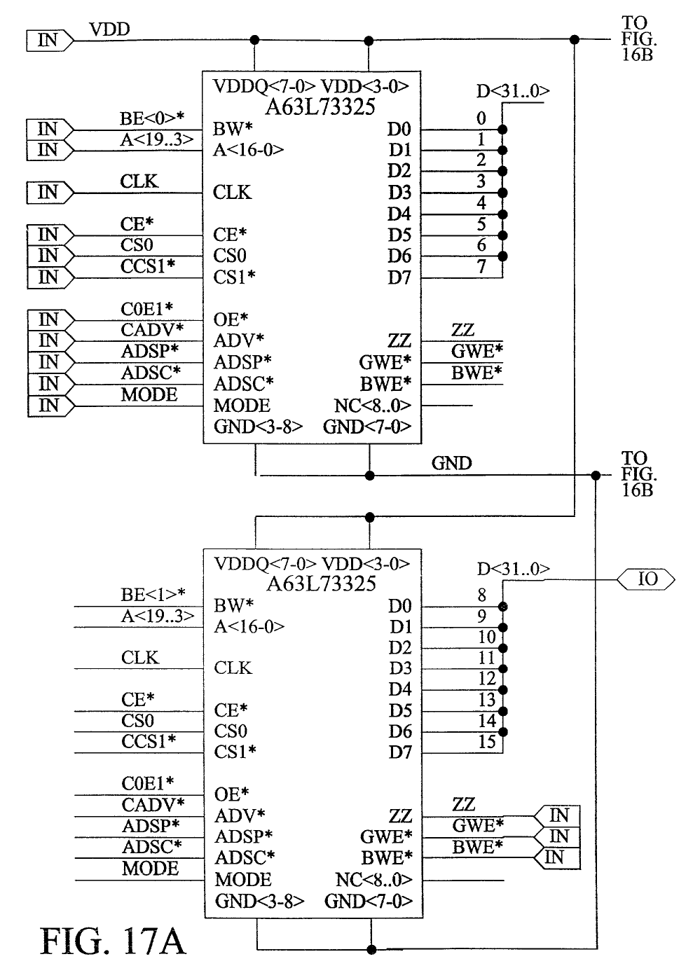

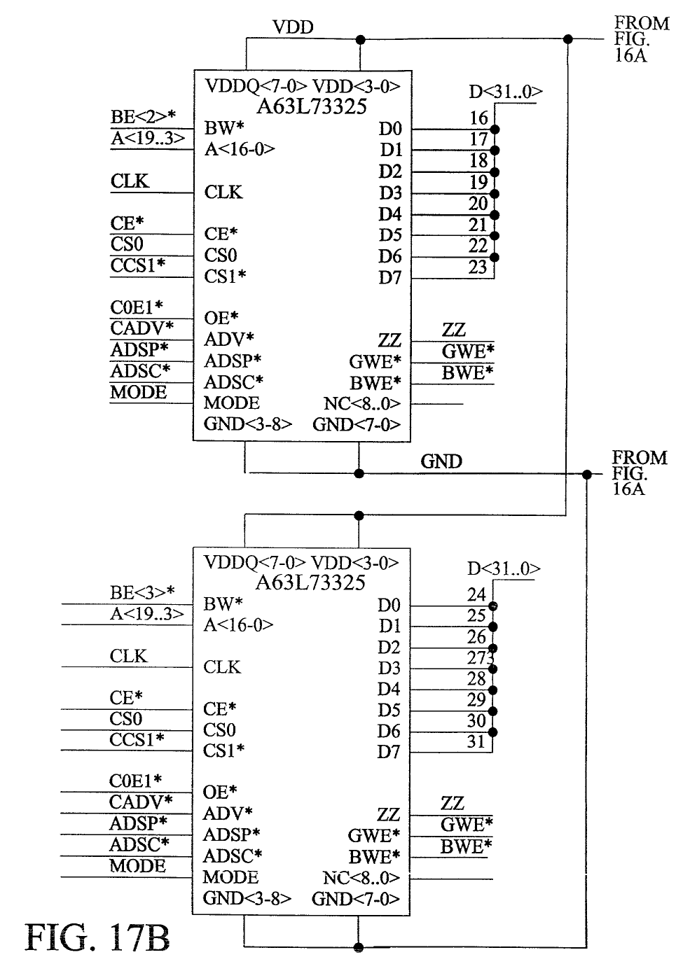

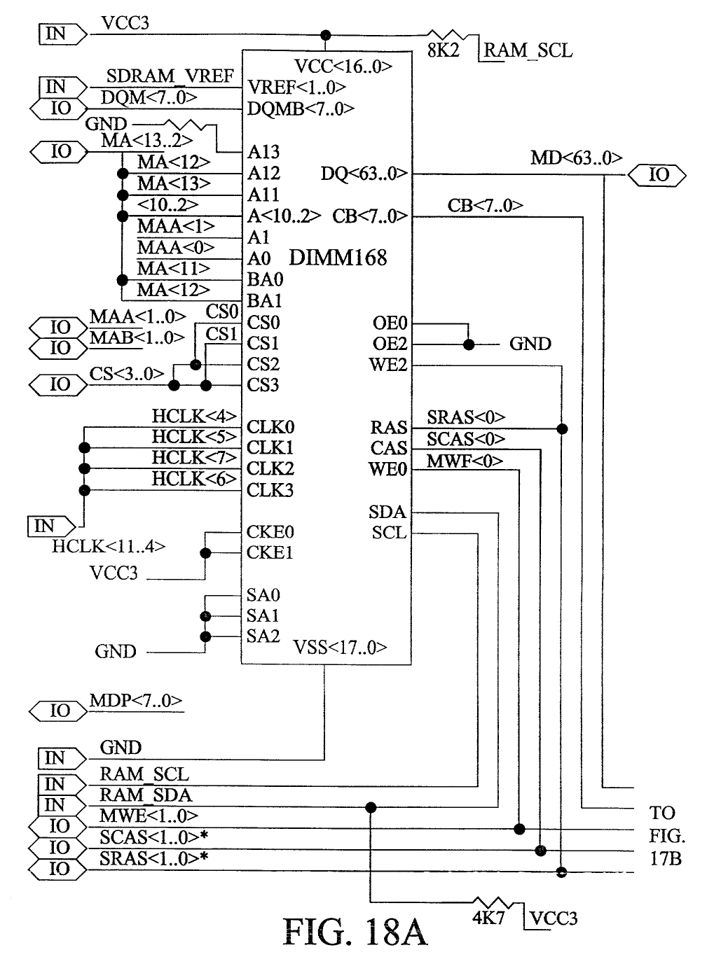

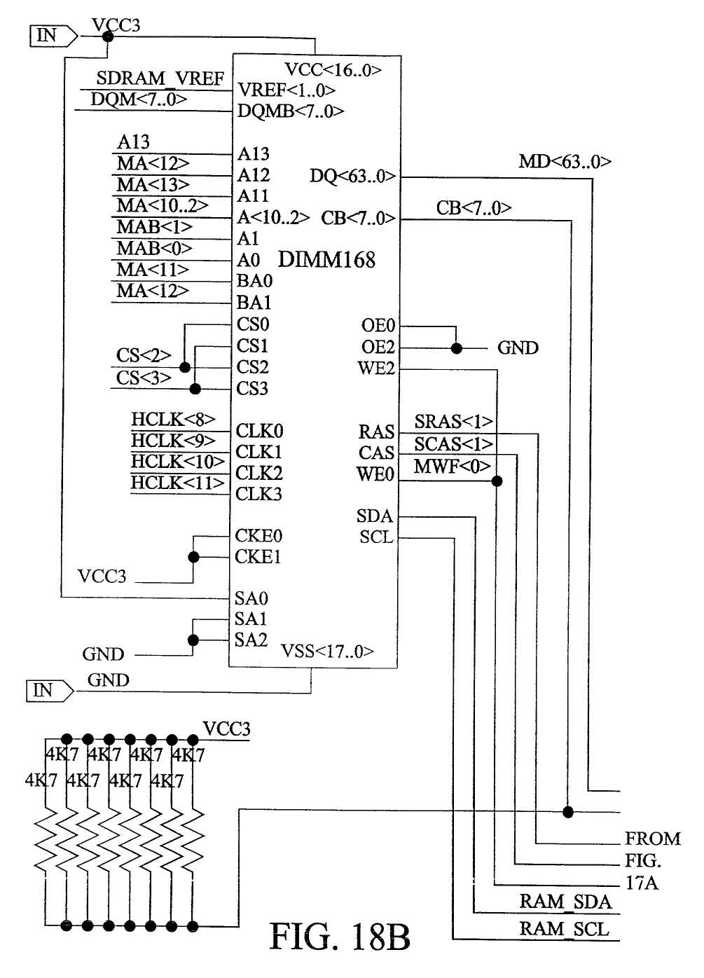

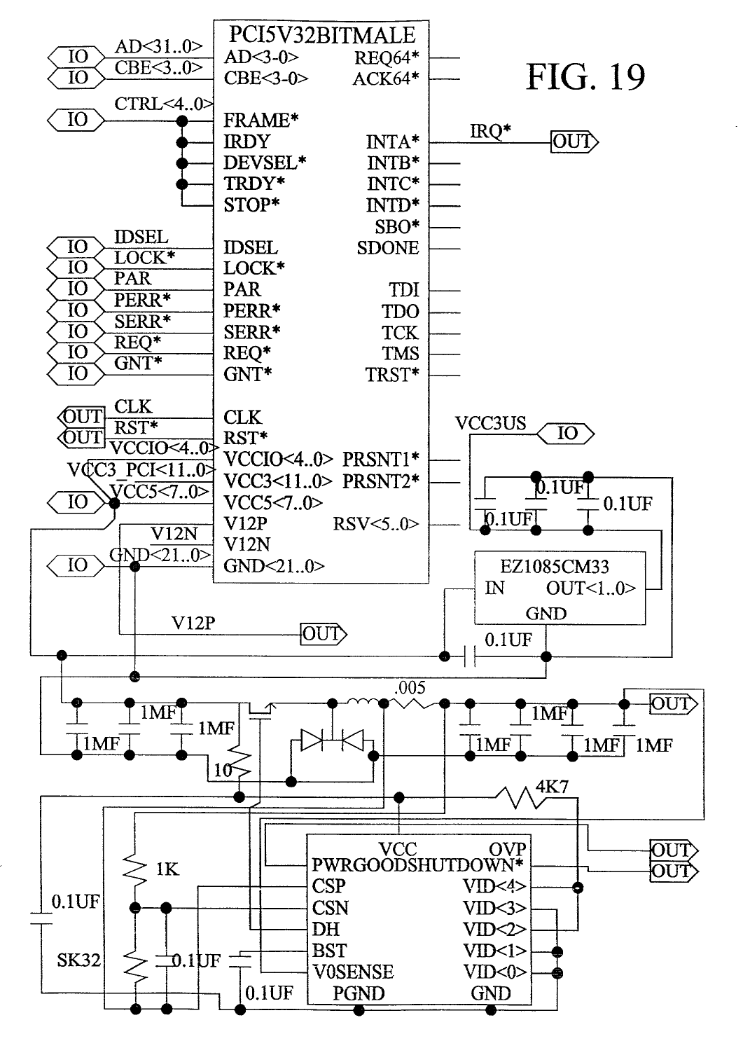

FIGS. 9-19 are an exemplary set of circuit diagrams for the upgrade card of FIG. 8 provided merely as an example of an implementation. It is to be understood that this is merely one example, and countless other implementations may be used, if desired.

The invention described herein includes many aspects which are desirable for a fully functional PCI based upgrade card. It is clearly to be understood that the invention includes various aspects, many of which are interrelated, but not necessarily required to be present for the invention. In addition, many of the aspects of the invention are applicable to computer system architecture in general, apart from a PCI based upgrade card.

The invention as described uses a single upgrade processor. Those skilled in the art can readily adapt the invention to utilize two or more upgrade processors on a single PCI upgrade card.

The invention as described uses a single PCI upgrade card in a host system. Those skilled in the art can readily adapt the invention to utilize two or more PCI upgrade cards in a single host system.

The invention as described is adapted for the industry standard Intel compatible x86-based personal computer system architecture. Those skilled in the art can readily adapt the invention for other computer architectures, such as, RISC-based workstations and Apple Power PC based personal computers.

The invention as described emphasizes the inclusion of an upgrade processor and upgrade memory. The upgrade card as described includes a local (to the upgrade card) PCI bus 240. Those skilled in the art can readily adapt the invention to include local PCI devices on the upgrade card such as 2D and 3D graphics controllers, network communications controllers, and other I/O devices. Similarly, other standard (and non-standard) buses can be included on the upgrade card together with associated devices, such as an AGP bus with associated AGP graphics devices.

Those skilled in the art can also readily adapt the invention to include various and multiple types of upgrade memory, for example cache memory, static random access memory (SRAM), dynamic random access memory (DRAM) and other types of memory types and devices.

The invention as described emphasized host computer features typically associated with desktop computers. The principles described herein can readily be applied by those skilled in the art to laptop and portable computers as well. For laptop applications it is preferable that the laptop has an internal or external port that directly accesses the PCI bus 116 to which an upgrade card is connected in any suitable manner.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

What is claimed is:

1. A computer system comprising:
(a) said computer system including a first processor and a PCI bus, said first processor being electrically coupled to said PCI bus;
(b) a second processor electrically coupled to said computer system only through said PCI bus; and
(c) said second processor executing operating system software for said computer system.
